(19) United States
(12) Patent Application Publication
(10) Pub. No.: US 2020/0171984 A1
(43) Pub. Date: Jun. 4, 2020

(54) LIFTER DEVICE

(71) Applicant: TOYOTA BOSHOKU KABUSHIKI KAISHA, Aichi (JP)

(72) Inventors: Yusuke KAJINO, Aichi-ken (JP); Yasuaki SUZUKI, Aichi-ken (JP)

(73) Assignee: TOYOTA BOSHOKU KABUSHIKI KAISHA, Aichi (JP)

(21) Appl. No.: 16/615,626

(22) PCT Filed: May 24, 2018
(86) PCT No.: PCT/JP2018/020067

§ 371 Date: Nov. 21, 2019

(30) Foreign Application Priority Data
May 25, 2017 (JP) 2017-103697
Nov. 7, 2017 (JP) 2017-214655
Apr. 27, 2018 (JP) 2018-086130

(51) Int. Cl. B60N 2/16

(52) U.S. Cl. CPC B60N 2/1685; B60N 2/1615; B60N 2/167

(57) ABSTRACT

A stopper is provided with a rotation shaft-side protrusion provided both on an outer circumferential surface of an outer circumferential surface part of a rotation shaft and on an end surface of a ratchet, and protrudes from each of the surfaces, an engagement member slidably supported on the outer circumferential surface, and engages with the rotation shaft-side protrusion in a rotation direction of the rotation shaft, and a support member-side protrusion provided to engage with the engagement member in the rotation direction such that a sliding surface part of a support member is formed concentric with the outer circumferential surface and a portion of the sliding surface part protrudes toward the outer circumferential surface part, wherein the sliding surface part faces the outer circumferential surface part so that the engagement member is slidably interposed between the support member and the outer circumferential surface.

### TECHNICAL FIELD

The present invention relates to a lifter device used in a seat of an automobile or the like.

### BACKGROUND ART

A lifter device used in a seat of an automobile or the like adjusts a height of a seat cushion with respect to a floor by operating an operation handle, and various types of lifter devices have been developed. According to the invention of PTL 1, when an operation handle is operated on a seat lifting side or a lowering side, a height is adjusted by a certain amount for each operation, and the operation of the operation handle is repeated until a desired height of a seated person is reached.

Specifically, a rotation control device is configured such that a pinion gear, which is coupled to a link mechanism so as to lift or lower the seat, is rotated by the operation of the operation handle on the seat lifting side or the lowering side. In the rotation control device, a rotation drive mechanism configured to rotationally drive the pinion gear and a lock mechanism configured to lock the rotation of the pinion gear are provided to a rotation shaft of the pinion gear.

When the operation handle is lifted, the pinion gear is driven to rotate so as to lift the seat by the rotation drive mechanism. At this time, the lock mechanism is locked at a position where the pinion gear is rotated by the operation of the operation handle.

When the operation handle is lowered, the rotation drive mechanism does not function, the lock mechanism releases the lock, and the pinion gear is rotated in the lowering direction of the seat. At this time, in order to reduce a lowering speed of the seat, the speed is reduced by a damper coupled to the rotation shaft of the pinion gear.

In a state in which the operation handle is not operated, the rotation of the pinion gear is locked by the lock mechanism, and the height of the seat is maintained.

Even in a state in which the seat reaches an upper limit position or a lower limit position and the operation handle is not operated, it is necessary to make the rotation drive mechanism and the lock mechanism function properly. For this reason, the rotation control device is provided with a stopper that restricts the rotation of the pinion gear at the upper limit position or the lower limit position of the seat.

FIG. 52 shows a configuration of a stopper of PTL 1. The stopper includes: a pin 101 protruding from a side wall of a ratchet forming a lock mechanism; a protrusion 103 protruding from a support member 102 of a rotation control device; and a ring 105 rotatably provided to an outer circumference of a rotation shaft 104 of a pinion gear and configured to be engaged with the pin 101 and the protrusion 103. When a seat reaches a position where rotation of the pinion gear is restricted at an upper limit position or a lower limit position, the pin 101 is engaged with the ring 105 which is engaged with the protrusion 103 to restrict the rotation, and the rotation of the ratchet and the pinion gear is restricted.

### CITATION LIST

### Patent Literature

PTL 1: JP-A-2016-132423

### SUMMARY OF INVENTION

### Technical Problem

When it is assumed that a large external force is applied so as to lift or lower the seat in a state in which the stopper functions, the stopper needs to have enough strength to withstand the large force. However, if the strength is increased, the stopper may be enlarged. In the configuration of FIG. 52, particularly, it is necessary to increase strength of the pin 101. When the pin 101 is enlarged, the ring 105 is also enlarged, and thus, the entire stopper is enlarged.

One object of the present invention is to make it possible to adjust a height of a seat by operating an operation handle, and to withstand a large force without enlarging a stopper in a lifter device including the stopper that limits a height adjustment operation at an upper limit position or a lower limit position of the height.

### Solution to Problem

According to a first aspect of the present invention, a lifter device includes:

a pinion gear configured to mesh with an input gear of a link mechanism that lifts and lowers a seat; and

a rotation control device configured to control rotation of the pinion gear, and the rotation control device includes:

a rotation shaft configured to rotate in synchronization with the pinion gear;

a support member rotatably supporting the rotation shaft;

a rotation drive mechanism configured to rotate the rotation shaft so as to correspond to an operation of an operation handle for lifting and lowering the seat;

a lock mechanism configured to lock the rotation of the rotation shaft at an operation end position of the operation handle; and

a stopper configured to restrict the rotation of the rotation shaft at an upper limit position or a lower limit position that restricts the lifting and lowering of the seat,

and the stopper includes:

a rotation shaft-side protrusion provided to an outer circumferential surface of the rotation shaft;

an engagement member slidably provided to the outer circumferential surface of the rotation shaft and engaged with the rotation shaft-side protrusion in a circumferential direction of the rotation shaft when the engagement member is at a predetermined engagement position in a rotation direction of the rotation shaft; and

a support member-side protrusion provided to the support member and engaged with the engagement member in the circumferential direction when the engagement member is at the engagement position,

and, when the seat is at the upper limit position or the lower limit position, the rotation of the rotation shaft is restricted by becoming a state where the engagement member is at the engagement position, and the engagement member is interposed between the rotation shaft-side protrusion and the support member-side protrusion.

According to the first aspect, since the engagement member is interposed between the rotation shaft-side protrusion and the support member-side protrusion, the rotation of the rotation shaft is restricted. Since the rotation shaft-side protrusion, the support member-side protrusion, and the engagement member are separate members, freedom in designing each of the rotation shaft-side protrusion, the support member-side protrusion, and the engagement member is high as compared with the related art described above. Therefore, for example, if at least one of the rotation shaft-side protrusion, the support member-side protrusion, and the engagement member has a shape having higher strength in the circumferential direction of the rotation shaft than the related art described above, the lifter device can withstand a large force without enlarging the stopper.

According to a second aspect of the present invention, in the first aspect,

the rotation drive mechanism is provided to the rotation shaft, configured to rotationally drive the rotation shaft in a lifting direction when the operation handle is operated to lift the seat, and configured to bring the rotation shaft into a freely rotatable state without rotationally driving the rotation shaft when the operation handle is operated to lower the seat,

the lock mechanism is provided to the rotation shaft, configured to lock the rotation of the rotation shaft at the operation end position of the operation handle when the operation handle is operated to lift the seat, and configured to bring the rotation shaft into the freely rotatable state without locking the rotation of the rotation shaft when the operation handle is operated to lower the seat,

the rotation shaft-side protrusion is provided across an outer circumferential surface of a small-diameter side outer circumferential surface part and an end surface of a large-diameter side outer circumferential surface part adjacent to each other in a step part, the step part being formed by making outer diameters of the outer circumferential surface of the rotation shaft different, and the rotation shaft-side protrusion protruding from each of the surfaces,

the engagement member is slidably supported on the outer circumferential surface of the small-diameter side outer circumferential surface part, and configured to engage with the rotation shaft-side protrusion in the rotation direction of the rotation shaft, and the support member-side protrusion is configured such that a sliding surface part of

the support member is concentric with the outer circumferential surface of the small-diameter side outer circumferential surface part, a portion of the sliding surface part protrudes toward the small-diameter side outer circumferential surface part and configured to engage with the engagement member in the rotation direction of the rotation shaft, the sliding surface part facing the small-diameter side outer circumferential surface part so that the engagement member is slidably interposed between the sliding surface part of the support member and the outer circumferential surface of the small-diameter side outer circumferential surface part.

In the second aspect, the end surface of the large-diameter side outer circumferential surface portion provided with the rotation shaft-side protrusion may be an end surface of a member constituting the lock mechanism or an end surface of a member provided exclusively.

According to the second aspect, the rotation shaft-side protrusion constituting the stopper is provided across the outer circumferential surface of the small-diameter side outer circumferential surface part and the end surface of the large-diameter side outer circumferential surface part. When the rotation shaft-side protrusion engages with the support member-side protrusion with the engagement member interposed therebetween to function as the stopper, the rotation shaft-side protrusion receives a reaction force accompanying engagement of the support member-side protrusion via the engagement member. At this time, the rotation shaft-side protrusion is supported by both the outer circumferential surface of the small-diameter side outer circumferential surface part and the end surface of the large-diameter side outer circumferential surface part. That is, the rotation shaft-side protrusion has shear surfaces in two directions when functioning as the stopper. For this reason, strength of the stopper can be improved without enlarging the rotation shaft-side protrusion.

According to a third aspect of the present invention, in the second aspect, a dimension of the engagement member in a radial direction of the rotation shaft is a value obtained by removing a gap between the engagement member and the small-diameter side outer circumferential surface part and a gap between the engagement member and the sliding surface part from a total value, the total value being a sum of a protrusion amount of the rotation shaft-side protrusion from the small-diameter side outer circumferential surface part, a protrusion amount of the support member-side protrusion from the sliding surface part and a gap between the rotation shaft-side protrusion and the support member-side protrusion.

According to the third aspect, an inner diameter of the sliding surface part of the support member is dimensioned such that the engagement member is interposed between the sliding surface part and the outer circumferential surface of the small-diameter side outer circumferential surface part, and the dimension of the engagement member in the radial direction is sized to be engageable with the rotation shaft-side protrusion and the support member-side protrusion as the stopper. Therefore, the inner diameter of the sliding surface part can be minimized in a range in which the engagement is possible. As a result, when the sliding surface part is formed on the support member, influence on other functions on the support member can be minimized, and the freedom in designing of the rotation shaft-side protrusion and the support member-side protrusion constituting the stopper can be improved.

In a fourth aspect of the present invention, in the second aspect, the engagement member integrally includes a ring formed concentric with the outer circumferential surface of the small-diameter side outer circumferential surface part, and the ring is configured such that an outer circumferential surface of the ring is slidable relative to a guide surface part of the support member-side protrusion facing the small-diameter side outer circumferential surface part, and an inner circumferential surface of the ring is slidable relative to an outer circumferential surface of the rotation shaft-side protrusion.

In the fourth aspect, the guide surface part may be divided into a plurality of portions along an outer circumference of the ring, or may be provided as one continuous portion.

According to the fourth aspect, the engagement member is integrated with the ring, the outer circumferential surface of the ring slides on the guide surface part of the support member-side protrusion, and the inner circumferential surface of the ring slides on the outer circumferential surface of the rotation shaft-side protrusion. Therefore, even when the engagement member is downsized, a posture thereof can be stabilized at all times.

According to a fifth aspect of the present invention, in the fourth aspect, the support member-side protrusion includes engagement surface parts configured to engage with the engagement member at two end parts in the rotation direction of the rotation shaft, a circumferential angle of the sliding surface part interposed between the two engagement surface parts is smaller than 180 degrees, and an inner diameter of the guide surface part is enlarged on an adjacent side of the guide surface part to each of the engagement surface parts such that the ring is movable off the guide surface part toward the sliding surface part side.

The circumferential angle of the sliding surface part of the support member interposed between the two engagement surface parts is smaller than 180 degrees, when the ring receives toward the sliding surface part side in a direction orthogonal to the rotation shaft, the ring may be caught by the guide surface part narrowed in the direction orthogonal to the rotation shaft. According to the fifth aspect, the inner diameter of the guide surface part is enlarged such that the ring is movable in the direction orthogonal to the rotation shaft on the sliding surface part side of the guide surface part. For this reason, a defect in which the ring is caught can be inhibited.

According to a sixth aspect of the present invention, in the first aspect, the rotation drive mechanism is configured to rotationally drive the rotation shaft in a lifting direction or a lowering direction by transmitting an operation force of the operation handle to the rotation shaft when the operation handle is operated to lift or lower the seat,

the lock mechanism allows the rotation of the rotation shaft and is configured to lock the rotation of the rotation shaft at an operation end position of the operation handle when the operation handle is operated to lift or lower the seat,

the rotation shaft-side protrusion protrudes radially from the outer circumferential surface of the rotation shaft,

the engagement member is an engagement piece slidably supported on the outer circumferential surface of the rotation shaft and configured to engage with the rotation shaft-side protrusion in the circumferential direction,

the stopper includes a sliding surface part which faces the outer circumferential surface of the rotation shaft via a gap capable of slidably sandwiching the engagement piece and is concentric with the outer circumferential surface of the rotation shaft,

the support member-side protrusion is provided on the support member corresponding to an inner circumferential side of the sliding surface part at a position radially away from the rotation shaft, and configured to engage with the engagement piece without being engaged with the rotation shaft-side protrusion in the circumferential direction, and

when the seat is at the upper limit position or the lower limit position, the rotation of the rotation shaft is restricted by engaging an end part of the rotation shaft-side protrusion and an end part of the support member-side protrusion, which face each other in the circumferential direction, while the engagement piece is sandwiched between the rotation shaft-side protrusion and the support member-side protrusion.

According to the sixth aspect, the rotation shaft-side protrusion protrudes in the radial direction from the outer circumferential surface of the rotation shaft, and engages with the support member-side protrusion via the engagement piece at the two end parts in the rotation direction of the rotation shaft-side protrusion. Moreover, the rotation shaft-side protrusion and the support member-side protrusion are not engaged with each other in the rotation direction, but engaged with the engagement piece interposed between the end parts facing each other in the rotation direction. An angle between the upper limit position and the lower limit position where the rotation shaft-side protrusion and the support member-side protrusion engage with each other with the engagement piece interposed therebetween can be larger than 360 degrees. For this reason, strength of the rotation shaft-side protrusion can be easily secured by securing a size of the rotation shaft-side protrusion in the rotation direction. As a result, the strength of the stopper can be ensured without enlarging the rotation shaft-side protrusion in the radial direction.

According to a seventh aspect of the present invention, in the sixth aspect, the support member is formed to have a circular container shape, and includes inner teeth that form a portion of the lock mechanism on an inner circumferential surface of an annular outer circumferential wall, the rotation shaft is rotatably inserted into a center of the circular shape of the support member, the lock mechanism includes a lock plate that is coupled to the rotation shaft so as to in synchronization with the rotation shaft in a state of being inserted into the circular container shape of the support member, and holds a pawl, at an outer circumferential side of the lock plate, that locks the rotation of the rotation shaft by engaging with the inner teeth, and the sliding surface part is formed on the lock plate.

According to the seventh aspect, the lock plate is used to form the sliding surface part. For this reason, the sliding surface part can be formed without increasing the number of components, and the device can be downsized.

### BRIEF DESCRIPTION OF DRAWINGS

FIG. 1 A side view of a seat to which a lifter device according to a first embodiment of the present invention is applied is shown.

FIG. 2 A side view from the inside of the seat of the first embodiment is shown.

FIG. 3 An exploded perspective view of a main part of the first embodiment is shown.

FIG. 4 A front perspective view of a rotation control device of the first embodiment is shown.

FIG. 5 A rear perspective view of the rotation control device of the first embodiment is shown.

FIG. 6 A front view of the rotation control device of the first embodiment is shown.

FIG. 7 A cross-sectional view taken along line A-A of FIG. 6 is shown.

FIG. 8 A cross-sectional view taken along line B-B of FIG. 6 is shown.

FIG. 9 An exploded perspective view of the rotation control device of the first embodiment is shown.

FIG. 10 An exploded perspective view of the rotation control device of the first embodiment seen from an angle different from FIG. 9 is shown.

FIG. 11 A cross-sectional view taken along line C-C of FIG. 8 is shown.

FIG. 12 A cross-sectional view taken along line D-D of FIG. 8 is shown.

FIG. 13 A cross-sectional view taken along line E-E of FIG. 8 is shown.

FIG. 14 A cross-sectional view similar to FIG. 11 showing a state in which an operation handle is operated to a lifting side by a first angle is shown.

FIG. 15 A cross-sectional view similar to FIG. 12 showing the state in which the operation handle is operated to the lifting side by the first angle is shown.

FIG. 16 A cross-sectional view similar to FIG. 13 showing the state in which the operation handle is operated to the lifting side by the first angle is shown.

FIG. 17 A cross-sectional view similar to FIG. 11 showing a state in which the operation handle is operated to a lowering side by a second angle is shown.

FIG. 18 A cross-sectional view similar to FIG. 12 showing the state in which the operation handle is operated to the lowering side by the second angle is shown.

FIG. 19 A cross-sectional view similar to FIG. 13 showing the state in which the operation handle is operated to the lowering side by the second angle is shown.

FIG. 20 A cross-sectional view taken along line F-F in FIG. 8 showing the state in which the operation handle is operated to the lifting side by the first angle is shown.

FIG. 21 A cross-sectional view similar to FIG. 20 showing a state in which the seat is at an upper limit position is shown.

FIG. 22 A cross-sectional view similar to FIG. 20 showing a state in which the seat is at a lower limit position is shown.

FIG. 23 An enlarged view of a part G of FIG. 20 is shown.

FIG. 24 An exploded perspective view of a main part of a rotation control device according to a second embodiment of the present invention is shown.

FIG. 25 A cross-sectional view of the second embodiment corresponding to FIG. 20 is shown.

FIG. 26 A perspective view of a rotation control device of a third embodiment of the present invention seen from the outside of the seat is shown.

FIG. 27 A perspective view of the rotation control device of the third embodiment seen from the inside of the seat is shown.

FIG. 28 A front view of the rotation control device of the third embodiment is shown.

FIG. 29 A cross-sectional view taken along line H-H of FIG. 28 is shown.

FIG. 30 A cross-sectional view taken along line I-I of FIG. 28 is shown.

FIG. 31 An exploded perspective view of the rotation control device seen from the outside of the seat is shown.

FIG. 32 An exploded perspective view showing an assembled state of a part of components shown in FIG. 31 is shown.

FIG. 33 An exploded perspective view showing a further assembled state of a part of components shown in FIG. 32 is shown.

FIG. 34 An exploded perspective view showing a further assembled state of a part of components shown in FIG. 33 is shown.

FIG. 35 An exploded perspective view of the rotation control device seen from the inside of the seat is shown.

FIG. 36 An exploded perspective view showing an assembled state of a part of components shown in FIG. 35 is shown.

FIG. 37 An exploded perspective view showing a further assembled state of a part of components shown in FIG. 36 is shown.

FIG. 38 A state diagram of a feed function of the rotation control device when the operation handle is at a neutral position is shown.

FIG. 39 A state diagram of a lock function is shown.

FIG. 40 A state diagram of the feed function when the operation handle is pushed down from the neutral position to a middle position is shown.

FIG. 41 A state diagram of the lock function is shown.

FIG. 42 A state diagram of the feed function when the operation handle is pushed down from the neutral position to a full stroke position is shown.

FIG. 43 A state diagram of the lock function is shown.

FIG. 44 A state diagram of the feed function when a pinion gear is rotated by action of gravity received from the seat side in a push-down operation state of the operation handle is shown.

FIG. 45 A state diagram of the lock function is shown.

FIG. 46 A state diagram of the feed function when the operation handle is returned from the push-down operation state to the neutral position is shown.

FIG. 47 A state diagram of the lock function is shown.

FIG. 48 A state diagram of the feed function when the operation handle is pulled up from the neutral position to a middle position is shown.

FIG. 49 A state diagram of the lock function is shown.

FIG. 50 A state diagram in which rotation of the pinion gear in a push-down operation direction is stopped by a stopper is shown.

FIG. 51 A state diagram in which the rotation of the pinion gear in a pull-up operation direction is stopped by the stopper is shown.

FIG. 52 A cross-sectional view showing a stopper of a rotation control device in a related art example of the present invention is shown.

### DESCRIPTION OF EMBODIMENTS

### First Embodiment

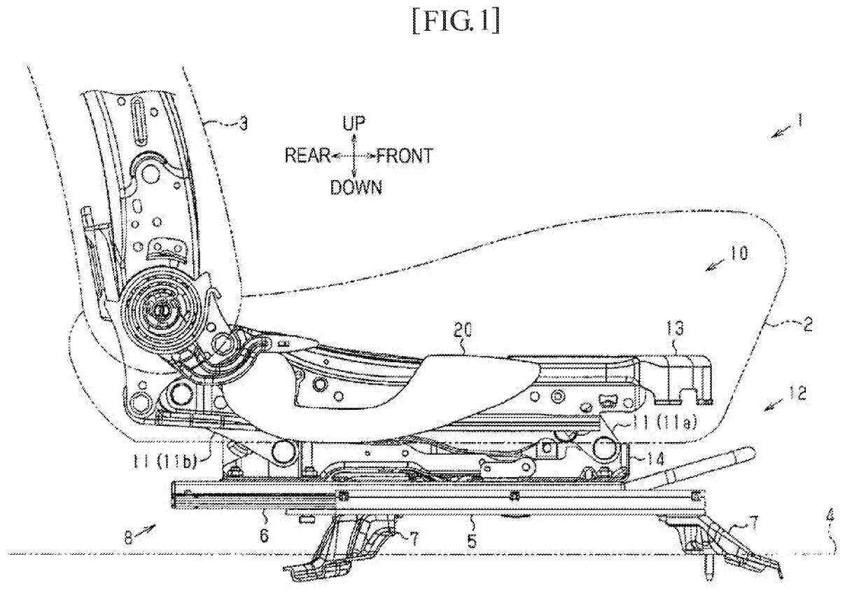

First, an overall configuration of a lifter device according to a first embodiment of the present invention will be described. FIGS. 1 to 3 show an automobile seat (hereinafter simply referred to as a seat) 1 to which the lifter device according to the first embodiment is applied. In the drawings, directions of parts in a state where the seat is mounted to an automobile are indicated by arrows. Description on direction is made on the basis of these directions in the following description.

As shown in FIG. 1, the seat 1 includes a seat back 3 serving as a backrest on a rear side of a seat cushion 2 serving as a seating part. The seat back 3 is rotatable in a front-rear direction with respect to the seat cushion 2. The seat cushion 2 includes a lifter device 10 and a seat slide device 8 at a lower part thereof, and is fixed to a vehicle floor 4 via a bracket 7.

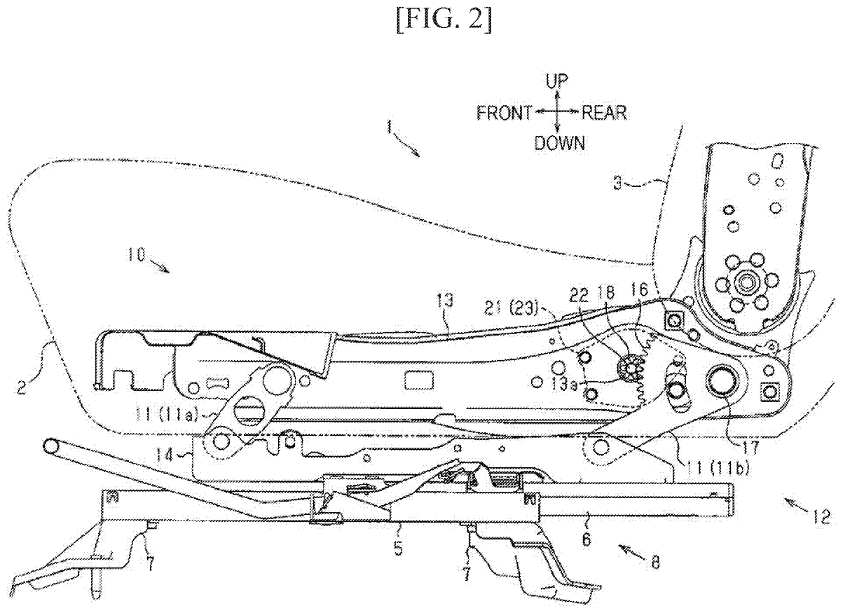

As shown in FIG. 2, the seat slide device 8 is known in the related art and includes a pair of left and right upper rails 6 coupled to a pair of left and right lower rails 5 extending in the front-rear direction, so as to be slidable in the front-rear direction. The left and right lower rails 5 are fixedly supported by a pair of front and rear brackets 7 fixed to the floor 4, respectively. The lifter device 10 is provided above the left and right upper rails 6.

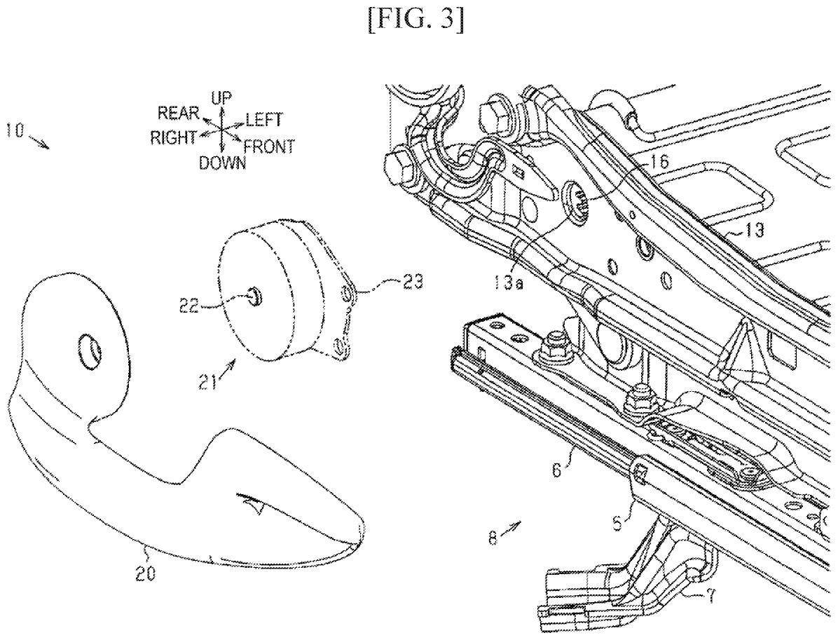

As shown in FIGS. 2 and 3, the lifter device 10 includes a base member 14 fixed on the upper rails 6, and a plurality of link members 11 rotatably coupled to front and rear end parts of the upper rails 6. A side frame 13 which is a framework member of the seat cushion 2, the base member 14, and the link members 11 constitute a link mechanism 12 that is a four-bar linkage. Among the plurality of link members 11, a rear link 11b on a right rear side includes a sector gear (corresponding to an input gear in the present invention) 16 and is configured to be rotated in the front-rear direction by a pinion gear 18 of a rotation control device 21. A rotation shaft of the rear link 11b on the right rear side with respect to the side frame 13 is configured by a torque rod 17. A rear link on a left rear side (not shown) is configured to be rotated in synchronization with the rear link 11b via the torque rod 17.

The side frame 13 is penetrated by a through-hole 13a for inserting the pinion gear 18. The rotation control device 21 is fixed to a right side wall of the side frame 13 such that the pinion gear 18 is inserted into the through-hole 13a. The rotation control device 21 is rotatable forward and reversely by an operation handle 20 that is provided on a right side part of the seat cushion 2 and extends in the front-rear direction. When the operation handle 20 is rotated upward, the rotation control device 21 is rotated such that the rear link 11b is erected from the base member 14. When the operation handle 20 is rotated downward, the rotation control device 21 is rotated such that the rear link 11b is folded on the base member 14. With the configuration of the above four-bar linkage, a front link 11a is also rotated in response to the rotation of the rear link 11b, such that the height of the seat cushion 2 from the floor 4 is adjusted in response to the operation of the operation handle 20.

<Configuration of Rotation Control Device 21 (Rotation Shaft 22 and Support Member 23)>

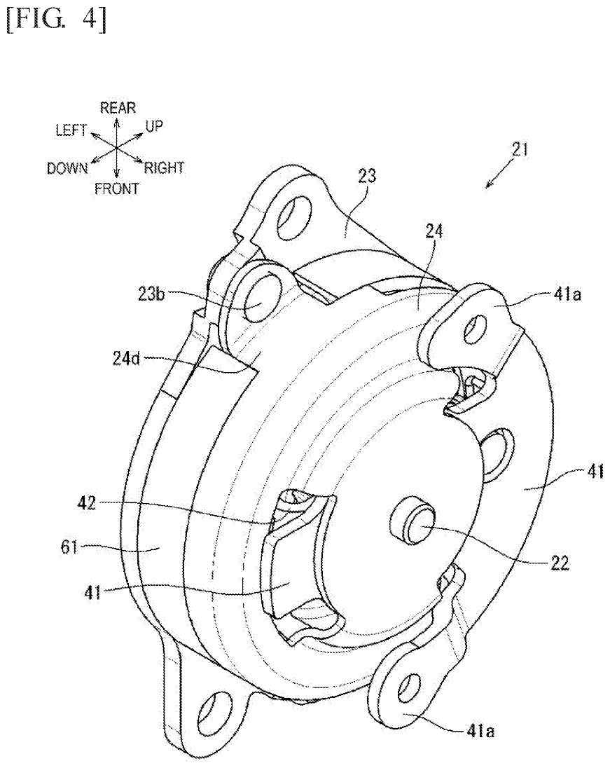

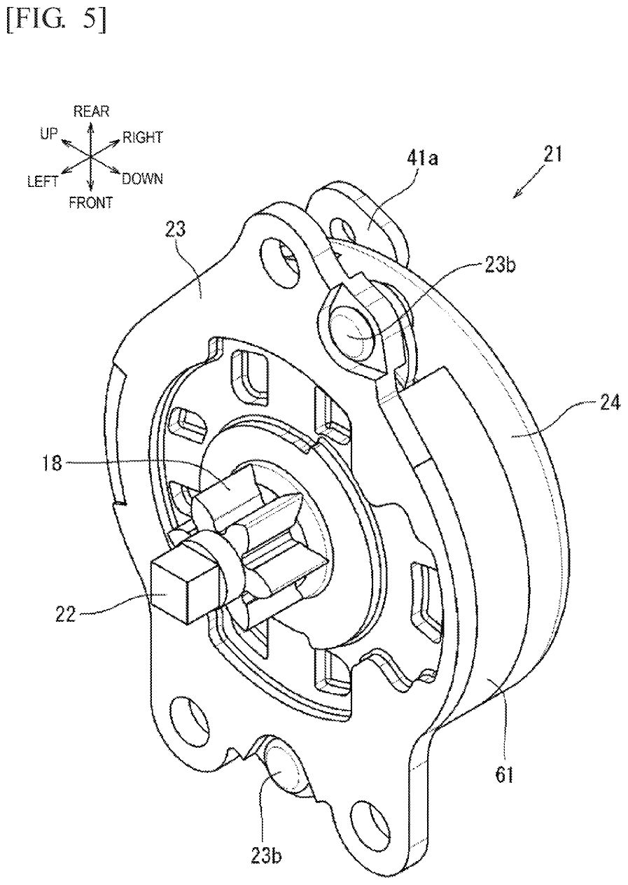

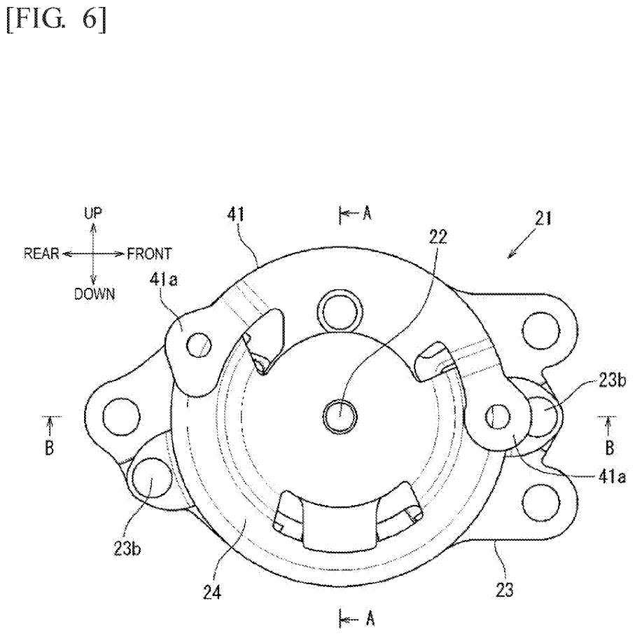

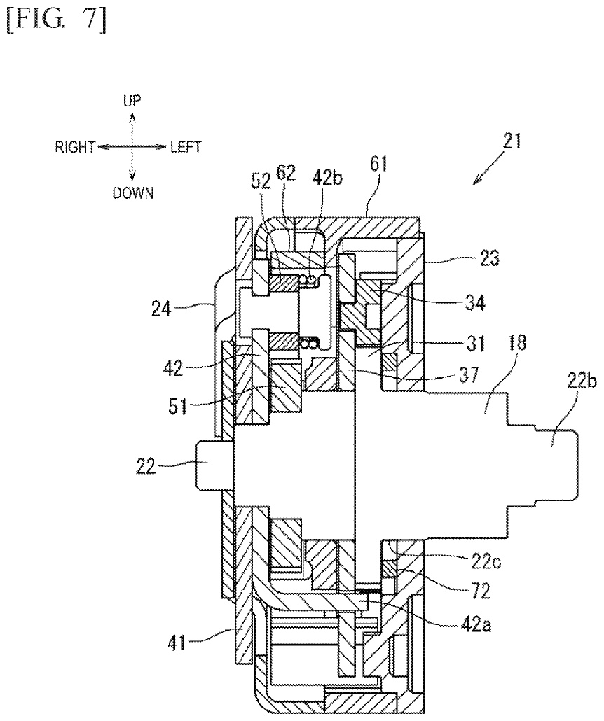

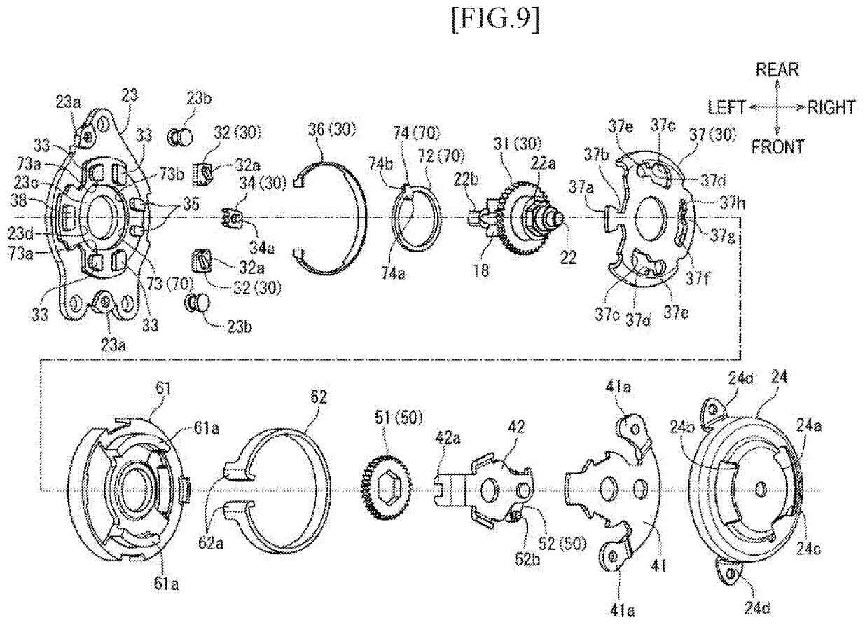

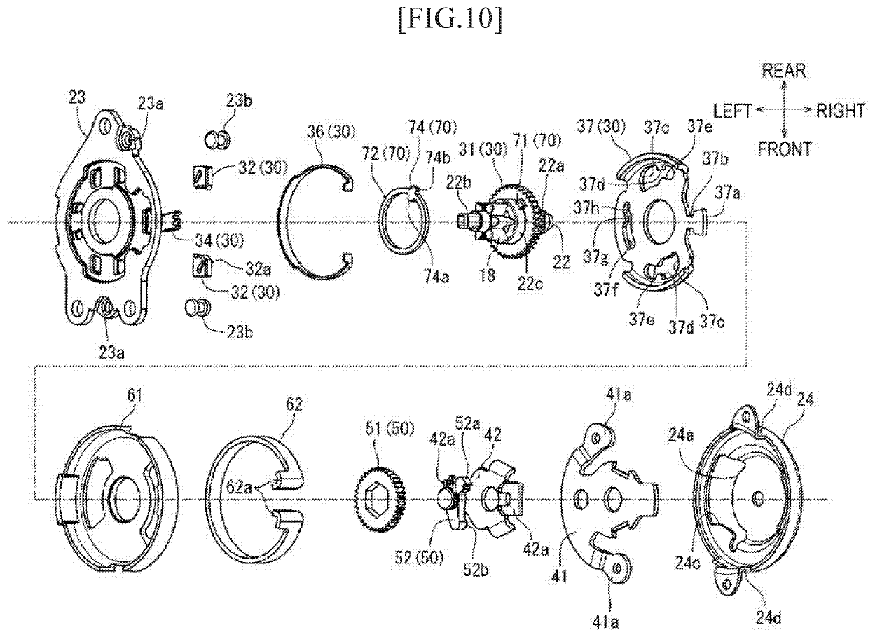

FIGS. 4 to 6 show a state in which the rotation control device 21 is detached from the seat cushion 2. Hereinafter, the configuration of the rotation control device 21 is described with reference to FIGS. 4 to 10.

The rotation control device 21 is integrated in a manner that a cap-shaped cover 24 is covered on a support member 23 which is a base member with a generally disc-shaped intermediate member 61 interposed therebetween. Two leg parts 24d of the cover 24 are caulked to through-holes 23a on the support member 23 by rivets 23b, such that the cover 24 is fixed to the support member 23 together with the intermediate member 61. A rotation shaft 22 passes through centers of the support member 23, the intermediate member 61 and the cover 24.

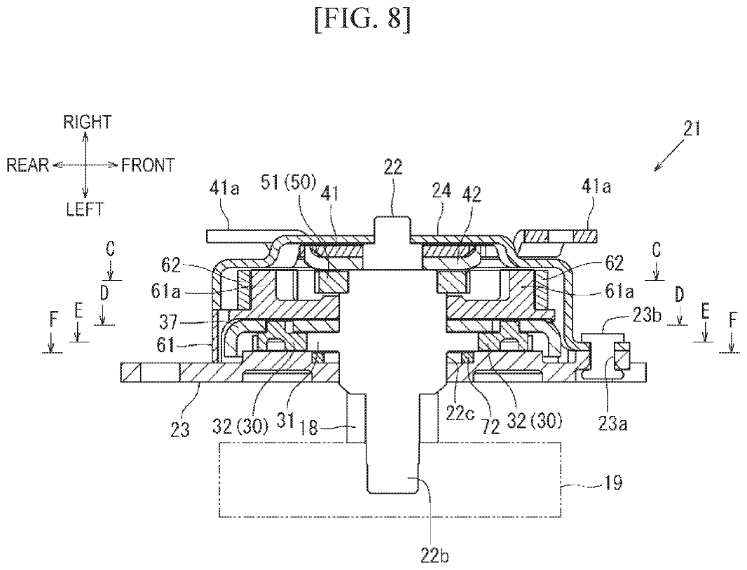

The rotation shaft 22 is integrally formed with the pinion gear 18 at a left end part, and a ratchet 31 is integrally formed between two ends thereof. A hexagonal part 22a is formed on the rotation shaft 22 on a right side of the ratchet 31. Further, a quadrangular part 22b having a quadrangular prism shape is formed at a left tip end of the pinion gear 18. Two ends of the rotation shaft 22 protrude from the support member 23 and the cover 24, and the pinion gear 18 is located at a position protruding from the support member 23. As shown in FIG. 8, a damper 19 is coupled to the quadrangular part 22b. As is well known, the damper 19 is adapted to inhibit a sudden change in a rotational speed of the rotation shaft 22.

<Configuration of Rotation Control Device 21 (Rotation Drive Mechanism 50)>

Arc-shaped openings 24a, 24b are formed in upper and lower parts of a right central part of the cover 24. A substantially T-shaped plate-shaped input member 41 is inserted into the openings 24a, 24b. The input member 41 is rotatably supported by the rotation shaft 22. End parts of the input member 41 protrude from the openings 24a, 24b. Coupling parts 41a on two upper ends of the input member 41 are coupled to the operation handle 20. Therefore, when the operation handle 20 is operated in an up-down direction, the input member 41 is rotated in an operation direction thereof. By inserting the input member 41 into the openings 24a, 24b in this manner, a rotational operation angle of the operation handle 20 is restricted.

A coupling member 42 is integrally coupled to a left side surface of the input member 41 so as to be rotatable with respect to the rotation shaft 22. A drive lever 52 of the rotation drive mechanism 50 is swingably supported at an upper end part of the coupling member 42. A ratchet 51 is provided on a left side surface of the coupling member 42. The ratchet 51 is fitted to the hexagonal part 22a of the rotation shaft 22 so as to rotate integrally with the rotation shaft 22. An engagement end part 52a engaging with a claw of the ratchet 51 is formed at a rear end part of the drive lever 52. An engagement part 52b engaging with an engagement piece 24c formed at the opening 24a of the cover 24 is formed at a front end part of the drive lever 52 to protrude to a right side. A spring 42b is hooked between the drive lever 52 and the coupling member 42, such that the engagement end part 52a is biased toward a side where the engagement end part 52a engages with the claw of the ratchet 51. The ratchet 51 and the drive lever 52 constitute a rotation drive mechanism 50 of the present invention.

<Configuration of Rotation Control Device 21 (Lock Mechanism 30)>

On a right side surface of the support member 23 and around the ratchet 31, a pair of main pawls 32 and a sub-pawl 34 are disposed in parallel to be able to engage with a claw of the ratchet 31 on an outer circumference. The pair of main pawls 32 is disposed at front and rear positions on two sides with the rotation shaft 22 interposed therebetween, and the sub-pawl 34 is disposed at an intermediate part of the pair of main pawls 32. The pair of main pawls 32 and the sub-pawl 34 are interposed between a pair of guide parts 33, 35 each provided on the support member 23. The pair of main pawls 32 and the sub-pawl 34 are prevented by the pair of guide parts 33, 35 from moving in a rotation direction of the rotation shaft 22 and are movably held in a radial direction of the rotation shaft 22. Therefore, the pair of main pawls 32 and the sub-pawl 34 are movable between a position where the pair of main pawls 32 and the sub-pawl 34 engage with the claw of the ratchet 31 and a position where the engagement is released. An annular ring spring 36 is disposed on an outer circumferential side of the pair of main pawls 32 and the sub-pawl 34, which always biases the pawls 32, 34 in a direction to engage with the claw of the ratchet 31. Engagement protrusions 32a, 34a are formed to protrude on right side surfaces of the pair of main pawls 32 and the sub-pawl 34.

A pawl operation member 37 is provided, between the support member 23 and the intermediate member 61, at a position where the pair of main pawls 32 and the sub-pawl 34 are covered from a right side. The pawl operation member 37 includes guide grooves 37c, 37f corresponding to the respective pawls 32, 34 and receiving the engagement protrusions 32a, 34a. A protrusion 37a extending in the radial direction is formed on a side of the pawl operation member 37 opposite to the guide groove 37f with the rotation shaft 22 interposed therebetween. A neck part 37b is formed at a root part of the protrusion 37a of the pawl operation member 37.

A lower end part of the coupling member 42 is bent leftward at a substantially right angle. An engagement part 42a is formed at a tip end of the lower end part of the coupling member 42 so as to pass through the intermediate member 61 and engage with the neck portion 37b of the pawl operation member 37 in the rotation direction of the rotation shaft 22. Therefore, the pawl operation member 37 is rotated via the coupling member 42 when the input member 41 is rotated, and is allowed to move between the position where the pawls 32, 34 engage with the claw of the ratchet 31 and the position where the engagement is released. In order to move the pawls 32, 34 by rotation of the pawl operation member 37, engagement protrusions 37d, 37e and 37g, 37h are formed in the guide grooves 37c and 37f, respectively, and protrude toward inner sides of the guide grooves 37c and 37f, respectively.

The ratchet 31, the pawls 32, 34, the ring spring 36, and the pawl operation member 37 constitute a lock mechanism 30 of the present invention.

<Configuration of Rotation Control Device 21 (Stopper 70)>

An outer circumferential surface part 22c is formed on a left side of the ratchet 31 and on a right side of the pinion gear 18. The outer circumferential surface part 22c is coaxial with the rotation shaft 22 and has a diameter smaller than that of the ratchet 31 and larger than that of the pinion gear 18. A rotation shaft-side protrusion 71 is integrally formed across the outer circumferential surface part 22c and a left side wall surface of the ratchet 31.

On a right side surface of the support member 23 and on an inner diameter side of the guide parts 33, 35, a circular guide recess 23c is formed along an outer circumferential side of the rotation shaft 22 by stamping the support member 23 to a left side. In the guide recess 23c, two circles having different diameters are formed concentrically with the rotation shaft 22. An inner circumferential surface of the circle having a larger diameter on a lower side serves as a sliding surface part 23d, and the circle having a smaller diameter on an upper side serves as a support member-side protrusion 73. An inner circumferential surface of the support member-side protrusion 73 serves as a guide surface part 73b. A step difference is formed at a boundary part between the two circles having different diameters, and engagement surface portions 73a are formed in a step part.

An annular ring 72 is fitted into the guide recess 23c so as to be rotatable along the guide surface part 73b. The ring 72 is positioned on an outer circumferential surface of the outer circumferential surface part 22c. An engagement member 74 is integrally formed on a portion of a circumference of the ring 72. A first engagement part 74a protrudes inward in a radial direction of the engagement member 74, and a second engagement part 74b protrudes outward in the radial direction. As shown in FIG. 20, when the ring 72 is rotated, the first engagement part 74a slides on the outer circumferential surface part 22c and engages with the rotation shaft-side protrusion 71 in the rotation direction. When the ring 72 is rotated, the second engagement part 74b slides along the sliding surface part 23d and engages with the engagement surface part 73a in the rotation direction.

Therefore, a stopper 70 is configured by the rotation shaft-side protrusion 71, the engagement member 74 integrated with the ring 72, and the support member-side protrusion 73. The outer circumferential surface part 22c corresponds to a small-diameter side outer circumferential surface part of the present invention, and the ratchet 31 corresponds to a large-diameter side outer circumferential surface part of the present invention. The step portion of the present invention is formed by the outer circumferential surface part 22c and the ratchet 31.

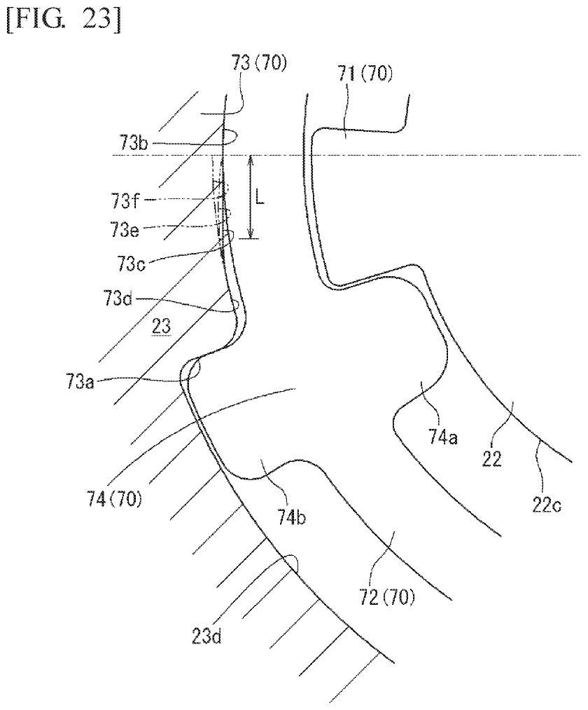

As shown in FIG. 23, an inner diameter of the support member-side protrusion 73 is enlarged in the vicinity of the engagement surface part 73a. Specifically, a lower side (engagement surface part 73a side) of a front-rear direction line (indicated by a one-dot chain line in FIG. 23) passing through a shaft core of the rotation shaft 22 is formed by a first enlarged diameter surface part 73c that forms a straight line extending downward by a predetermined dimension L. A lower side (engagement surface part 73a side) of the first enlarged diameter surface part 73c is formed by a second enlarged diameter surface part 73d which is an arc surface along an outer shape line of the ring 72. FIG. 23 shows only the vicinity of the engagement surface 73a on a rear side, and the inner diameter of the support member-side protrusion 73 is similarly enlarged in the vicinity of the engagement surface part 73a on a front side.

A reason why the inner diameter of the support member-side protrusion 73 is enlarged in this manner is to reduce the possibility that the ring 72 is interposed and caught between the narrowed engagement surface parts 73a when the ring 72 receives a force of moving toward the engagement surface part 73a side in the up-down direction. That is, the ring 72 is easily caught when a front-rear direction distance between the pair of engagement surfaces 73a is shorter than an outer diameter of the ring 72 below the front-rear direction line (shown by the one-dot chain line in FIG. 23) passing through the shaft core of the rotation shaft 22 between the pair of front and rear engagement surface parts 73a. As described above, when the inner diameter of the support member-side protrusion 73 is enlarged in the vicinity of the engagement surface part 73a, the ring 72 can move along the first enlarged diameter surface part 73c when the ring 72 receives the force of moving toward the engagement surface part 73a side. During this movement, a lower end of the ring 72 abuts against the sliding surface part 23d, and the movement of the ring 72 is stopped. Therefore, the ring 72 is prevented from being interposed and caught between the guide surface portions 73b of the support member-side protrusion 73. The predetermined dimension L is determined to be necessary to inhibit the being caught of the ring 72 in consideration of a movement amount for the lower end of the ring 72 to abut against the sliding surface part 23d.

In particular, as shown in FIG. 23, when the rotation shaft-side protrusion 71 is rotated counterclockwise and presses the first engagement part 74a downward, the phenomenon described above in which the ring 72 is moved downward occurs easily. In a case where the sliding surface part 23d is disposed on a lower side in the rotation control device 21, the ring 72 is easily moved toward the sliding surface part 23d side due to gravity, thus the above-described phenomenon occurs easily.

As shown by virtual lines in FIG. 23, enlargement of an inner diameter of the guide recess 23c may be formed with a third enlarged diameter surface part 73e formed by an arc surface at a portion corresponding to the first enlarged diameter surface part 73c. The portion corresponding to the first enlarged diameter surface part 73c may be formed with a fourth enlarged diameter surface part 73f, and may be an arc surface extending along the out shape line of the ring 72 as a whole from the second enlarged diameter surface part 73d to the fourth enlarged diameter surface part 73f.

<Configuration of Rotation Control Device 21 (Alignment of Pawl Operation Member 37)>

At a position located on a lower side part of the support member 23 and facing the protrusion 37a of the pawl operation member 37, a protrusion 38 having a size corresponding to the protrusion 37a as a whole is formed by stamping a plate material of the support member 23 from the left side. A ring spring 62 is provided on a right side surface of the intermediate member 61. The ring spring 62 has an open ring shape that is partially cut off, and a spring force is applied thereto in a direction to contract an inner diameter thereof. A pair of arc walls 61a is formed on a right side surface of the intermediate member 61 on a circle concentric with the rotation shaft 22, such that the ring spring 62 is held on an outer circumferential side of the arc walls 61a. An opening end part of the ring spring 62 located at the cut-off part is configured to extend to the left side (the support member 23 side) to form extending end parts 62a. Tip ends (left ends) of the extending end parts 62a are abutted against a surface of the support member 23, and the protrusion 38 and the protrusion 37a are fitted between the extending end parts 62a. For this reason, the protrusion 37a is biased to be aligned to a position facing the protrusion 38 by a spring force of the ring spring 62. That is, in a state where the pawl operation member 37 is not rotated by the operation handle 20, a rotation angle thereof coincides with the protrusion 38, which is a reference position.

<Operation of Rotation Control Device 21>

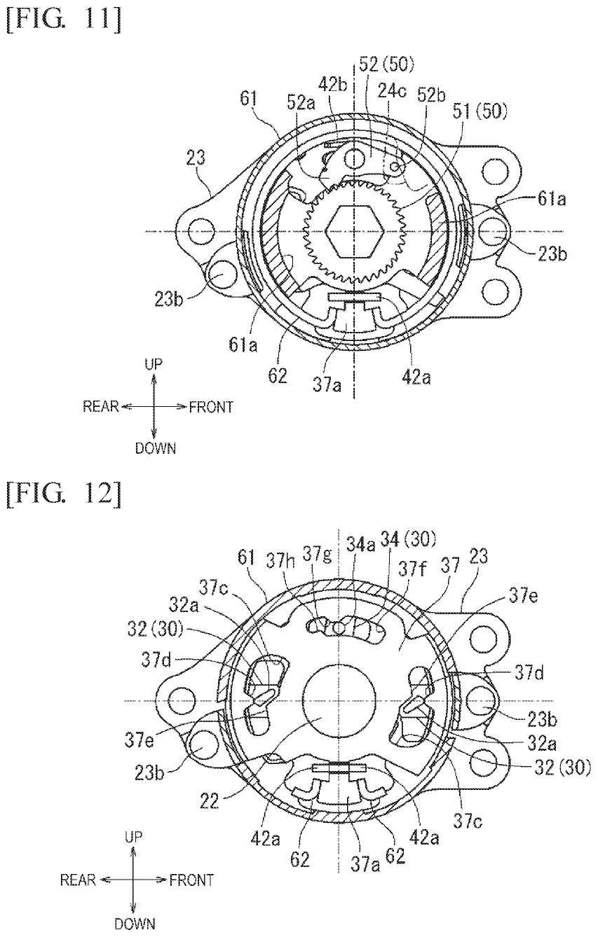

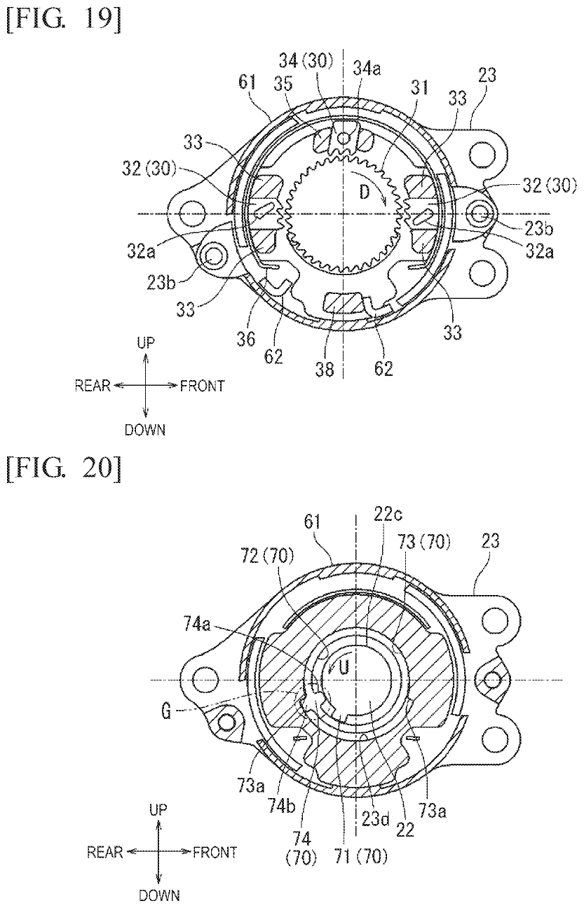

Hereinafter, a height adjustment operation of the seat cushion 2 performed by the rotation control device 21 is described with reference to FIGS. 11 to 22.

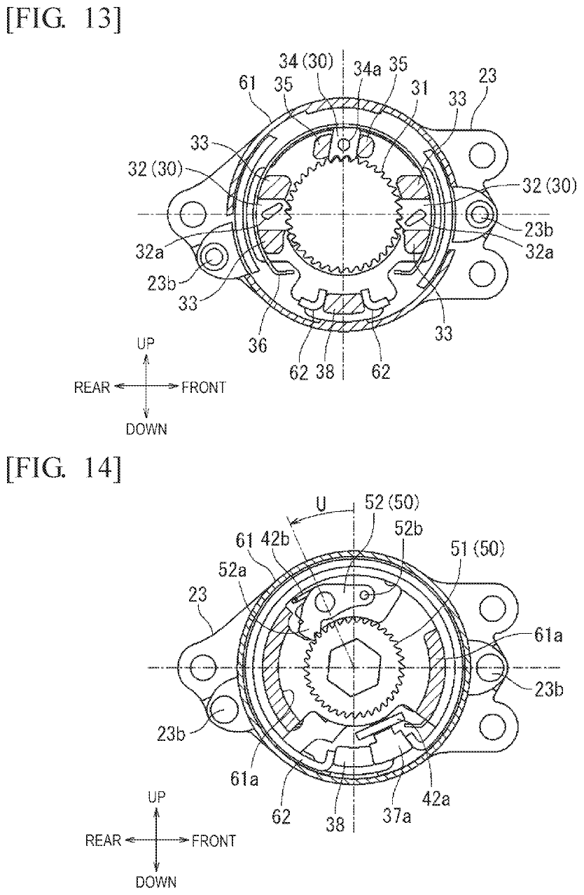

FIGS. 11 to 13 show a state of a neutral position in which the operation handle 20 is not operated, and the input member 41 and the pawl operation member 37 are not rotated. At this time, as shown in FIG. 11, the drive lever 52 is biased by the spring 42b, and the engagement end part 52a is engaged with the claw of the ratchet 51. As shown in FIGS. 12 and 13, the main pawls 32 are in a state of being pressed by the ring spring 36 and engaged with the ratchet 31. In this state, the engagement protrusions 37d are engaged with the engagement protrusions 32a and maintained in a state of being engaged with the ratchet 31. The engagement protrusion 34a is pressed toward the ratchet 31 by the engagement protrusion 37g, such that the sub-pawl 34 is engaged with the ratchet 31. Therefore, the lock mechanism 30 is in a lock state, the ratchet 31 is not rotated, and the height of the seat 1 is not changed on a lifting side and a lowering side.

In such state where the operation handle 20 is at the neutral position, the rotation angle of the pawl operation member 37 is aligned accurately to the reference position by aligning the protrusion 37a with the protrusion 38.

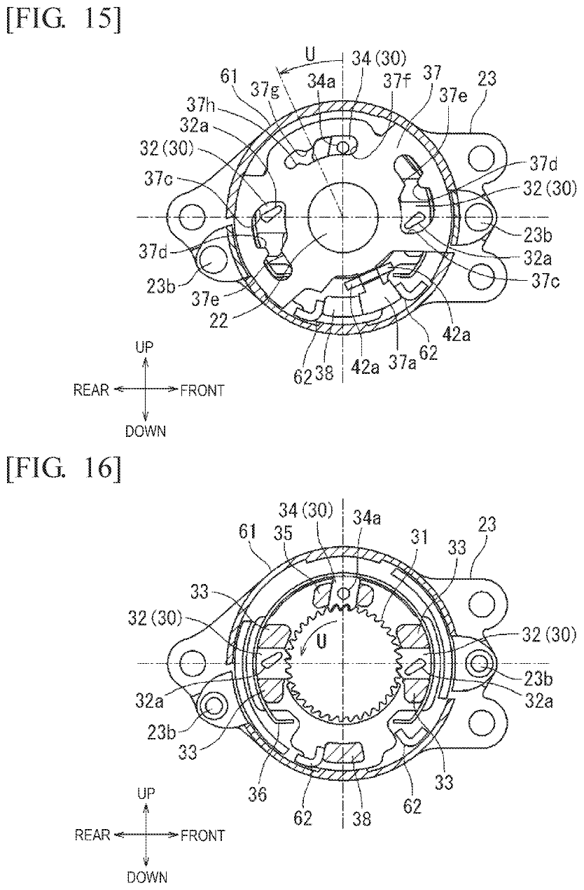

FIGS. 14 to 16 show a state where the operation handle 20 is operated by a first angle U in a seat lifting direction. At this time, as shown in FIG. 14, the drive lever 52 rotates the ratchet 51 by the first angle U in a state where the engagement end part 52a is engaged with the claw of the ratchet 51. As shown in FIG. 15, the pawl operation member 37 is also rotated by the first angle U via the coupling member 42. As a result of rotating the pawl operation member 37, the engagement protrusions 32a of the main pawls 32 are not pressed by the engagement protrusions 37d. The engagement protrusion 34a of the sub-pawl 34 is also not pressed by the engagement protrusion 37g. Therefore, as shown in FIG. 16, the main pawls 32 and the sub-pawl 34 are biased by the ring spring 36 in a direction to engage with the ratchet 31. In this state, the ratchet 31 which is rotated together with the ratchet 51 can be rotated without being engaged with the claws of the main pawls 32 and the sub-pawl 34. As a result, the pinion gear 18 is rotated to lift the seat 1 by an amount corresponding to the first angle U.

When the operation of the operation handle 20 in the seat lifting direction is ended, the main pawls 32 and the sub-pawl 34 are engaged with the ratchet 31 by the biasing of the ring spring 36. Since the pawl operation member 37 is returned to the neutral position, and the engagement protrusions 37d and the engagement protrusion 37g of the pawl operation member 37 are engaged with the ratchet 31 to lock the ratchet 31.

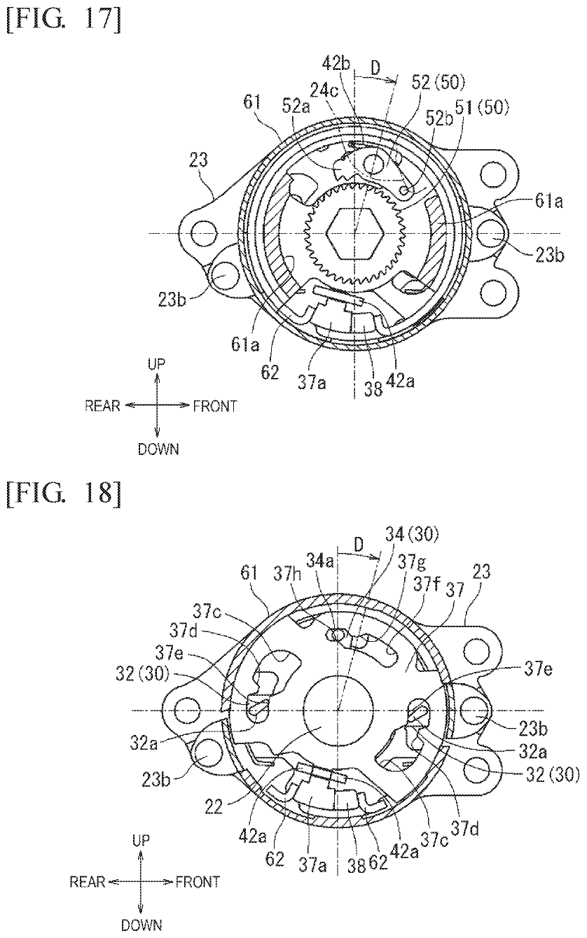

FIGS. 17 to 19 show a state in which the operation handle 20 is operated by a second angle D in a seat lowering direction from the neutral position, and the pawl operation member 37 is rotated by the second angle D in the seat lowering direction from the neutral position. As a result of rotating the pawl operation member 37, the engagement protrusions 32a of the main pawls 32 are not pressed by the engagement protrusions 37d, and the main pawls 32 are moved by engaging with the engagement protrusion 37e in a direction to disengage from the ratchet 31. Meanwhile, the engagement protrusion 34a of the sub-pawl 34 is not pressed by the engagement protrusion 37g and is moved along an inclined surface of the engagement protrusion 37h. For this reason, the main pawls 32 and the sub-pawl 34 are disengaged from the ratchet 31. Therefore, in this state, the lock state of the ratchet 31 is released and the ratchet 31 is freely rotatable. As a result, the pinion gear 18 is rotated and the seat 1 is lowered. At this time, since the damper 19 is connected to the pinion gear 18, a lowering speed of the seat 1 is appropriately reduced.

When the operation of the operation handle 20 in the seat lowering direction is ended, the main pawls 32 and the sub-pawl 34 are engaged with the ratchet 31 by the biasing of the ring spring 36. Since the pawl operation member 37 is returned to the neutral position, and the engagement protrusions 37d and the engagement protrusion 37g of the pawl operation member 37 are engaged with the ratchet 31 to lock the ratchet 31.

As described above, when lifting the seat 1, the operation handle 20 is operated to rotate in the lifting direction, and the ratchet 51 is rotated in accordance with the operation amount, such that the seat 1 is lifted. When the lifting amount is insufficient, the seat 1 can be lifted by further repeating the rotation operation of the operation handle 20.

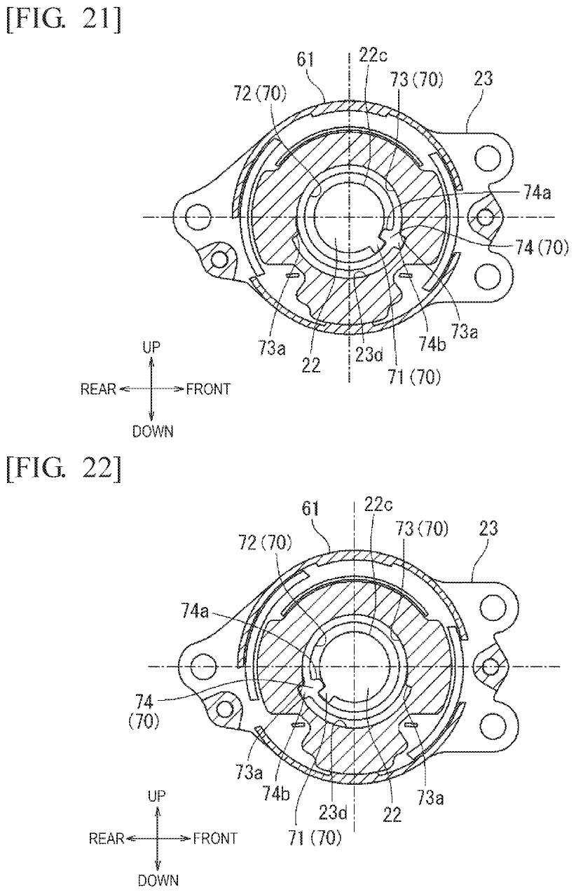

When the ratchet 31 and the rotation shaft 22 are rotated, as illustrated in FIG. 20, the rotation shaft-side protrusion 71 is also rotated. The ring 72 is not rotated while the first engagement part 74a of the ring 72 is positioned rearward in the rotation direction. However, when rotation angles of the ratchet 31 and the rotation shaft 22 increase, and the first engagement part 74a is located in front of the rotation shaft-side protrusion 71 and pressed by the rotation shaft-side protrusion 71, the ring 72 is rotated together with the ratchet 31 and the rotation shaft 22. Eventually, when the height of the seat 1 reaches an upper limit position, as shown in FIG. 21, the second engagement part 74b of the ring 72 abuts against the front engagement surface parts 73a, such that the rotation of the ring 72 is restricted. For this reason, the rotation shaft-side protrusion 71 cannot be rotated by the first engagement part 74a, and the rotation of the ratchet 31 and the rotation shaft 22 is restricted. Therefore, the pinion gear 18 cannot be rotated, and the lifting of the seat 1 is stopped.

When lowering the seat, the operation handle 20 is operated to rotate in the lowering direction, and the lock state of the ratchet 31 is released by the main pawls 32 and the sub-pawl 34, such that the seat 1 is lowered.

FIG. 22 shows a state in which the height of the seat 1 reaches a lower limit position. Before reaching the lower limit position, the first engagement part 74a of the ring 72 is pressed by the rotation shaft-side protrusion 71 and rotated clockwise in FIG. 22, such that the second engagement part 74b abuts against the rear engagement surface parts 73a to restrict the rotation. Therefore, the rotation of the ratchet 31 and the rotation shaft 22 is restricted and the pinion gear 18 cannot be rotated, such that the lowering of the seat 1 is stopped.

<Effect of First Embodiment>

According to the above-described embodiment, the rotation shaft-side protrusion 71 constituting the stopper 70 is provided across the outer circumferential surface of the outer circumferential surface part 22c and an end surface of the ratchet 31. When the first engagement part 74a of the ring 72 is engaged with the rotation shaft-side protrusion 71 to function as the stopper 70, the rotation shaft-side protrusion 71 receives a force in the rotation direction of the ring 72. At this time, the rotation shaft-side protrusion 71 is supported by both the outer circumferential surface of the outer circumferential surface part 22c and the end surface of the ratchet 31. That is, the rotation shaft-side protrusion 71 has shear surfaces in two directions when functioning as the stopper 70. For this reason, strength of the stopper 70 can be improved without enlarging the rotation shaft-side protrusion 71.

### Second Embodiment

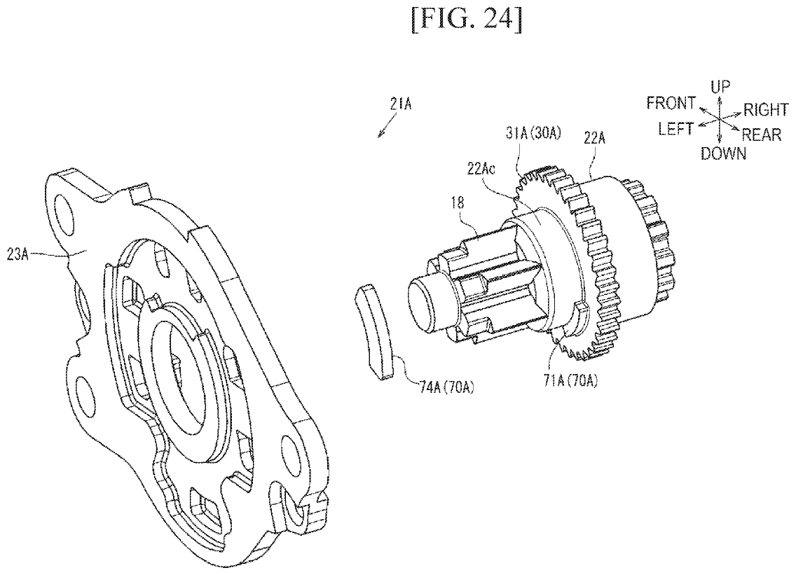

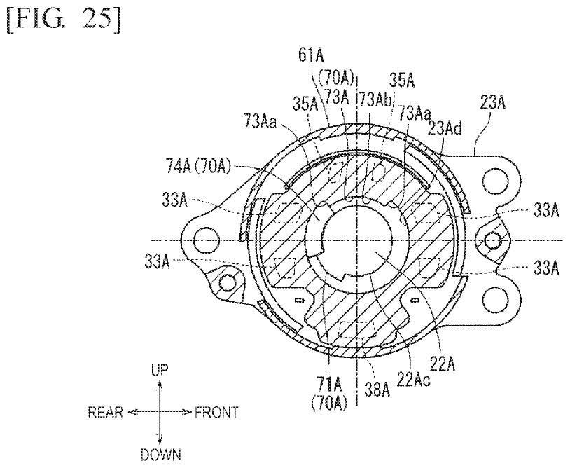

Hereinafter, a configuration of a rotation control device 21A of a lifter device according to a second embodiment of the present invention (stopper 70A) will be described. FIG. 24 only shows a rotation shaft 22A, a support member 23A, and an engagement member 74A in the rotation control device 21A according to the second embodiment. Since the other components are substantially the same as those of the first embodiment, a description thereof is omitted. FIG. 25 is related to the second embodiment corresponding to FIG. 20.

The second embodiment is characterized in that the ring 72 is provided integrally with the engagement member 74 in the first embodiment, whereas the ring 72 is not provided in the second embodiment. As is clear from comparison between FIG. 20 and FIG. 25, in the second embodiment, an inner diameter of a sliding surface part 23Ad is reduced since the ring 72 is not provided, and a length of a support member-side protrusion 73A in the circumferential direction is shortened. Further, the engagement member 74A and a rotation shaft-side protrusion 71A have longer lengths in the circumferential direction. Other configurations are the same, and descriptions of the same parts are not repeated.

<Effect of Second Embodiment>

In the second embodiment, since the inner diameter of the sliding surface part 23Ad is reduced as compared with the first embodiment, a distance in a planar direction between guide portions 33A, 35A formed on the support member 23A can be secured, and a length of the sliding surface part 23Ad in the circumferential direction can be longer than the support member-side protrusion 73A. As a result, the lengths of the engagement member 74A and the rotation shaft-side protrusion 71A in the circumferential direction can be increased, and it is easy to secure strength of the engagement member 74A and the rotation shaft-side protrusion 71A when functioning as the stopper 70A. Therefore, freedom can be increased in selecting materials constituting the engagement member 74A and the rotation-side protrusion 71A.

Since the engagement member 74A has a long length in the circumferential direction, the engagement member 74A can be stably supported between the sliding surface part 23Ad and an outer circumferential surface part 22Ac of the rotation shaft 22A without providing the ring 72 as in the first embodiment.

Further, a dimension of the engagement member 74A is reduced in the radial direction since the ring 72 is not provided. The dimension of the engagement member 74A in the radial direction of the rotation shaft 22A is a value obtained by removing a gap between the engagement member 74A and the outer circumferential surface part 22Ac and a gap between the engagement member 74A and the sliding surface part 23Ad from a total value of a protrusion amount of the rotation shaft-side protrusion 71A from the outer circumferential surface part 22Ac, a protrusion amount of the support member-side protrusion 73A from the sliding surface part 23Ad and a gap between the rotation shaft-side protrusion 71A and the support member-side protrusion 73A. For this reason, when functioning as the stopper, shear forces received by the engagement member 74A from the rotation shaft-side protrusion 71A and the support member-side protrusion 73A can be reduced.

### Third Embodiment

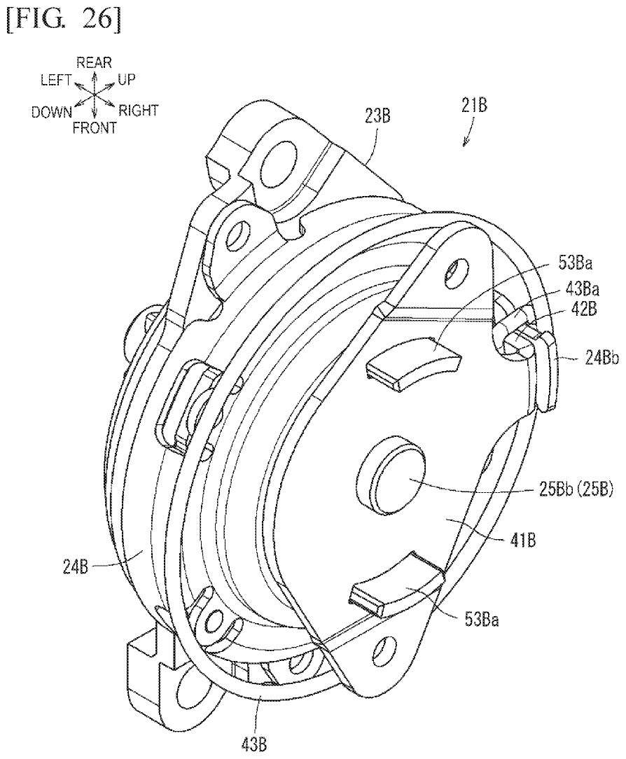

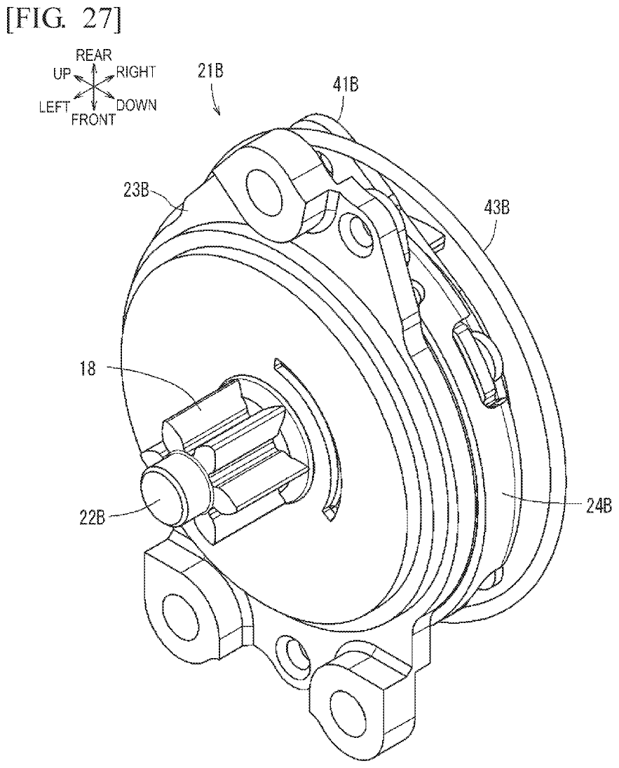

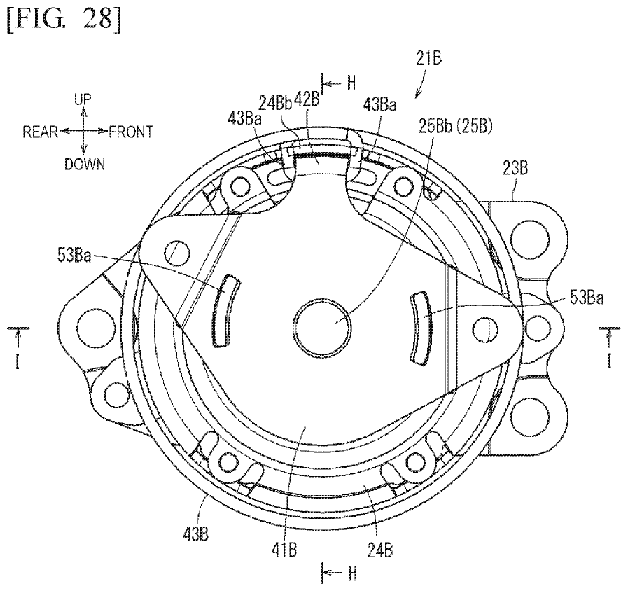

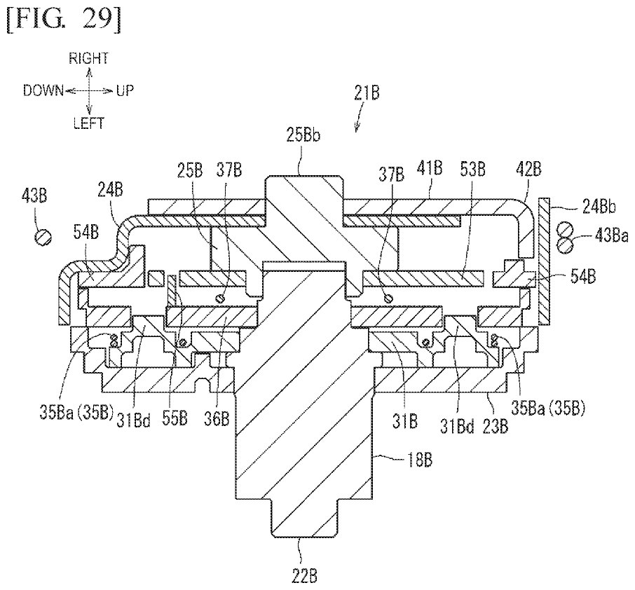

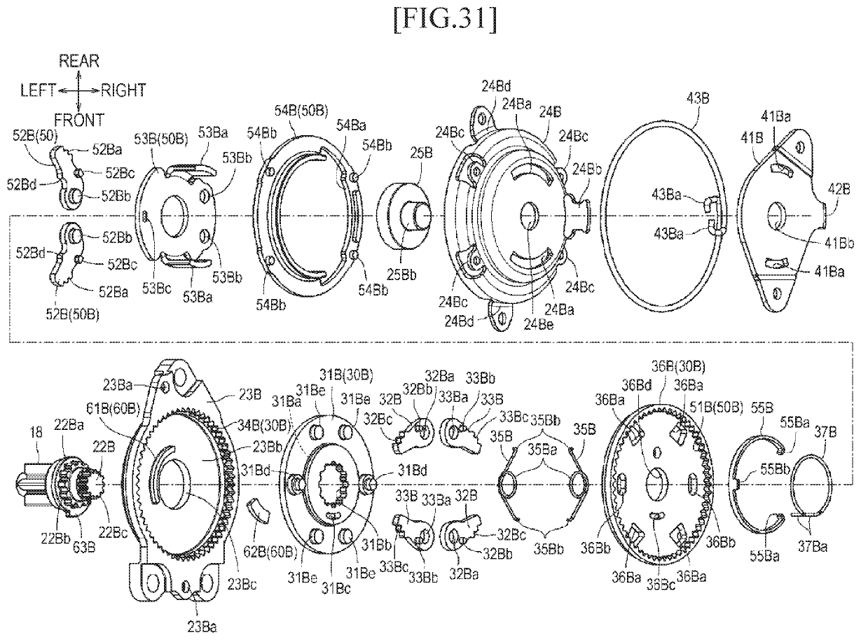

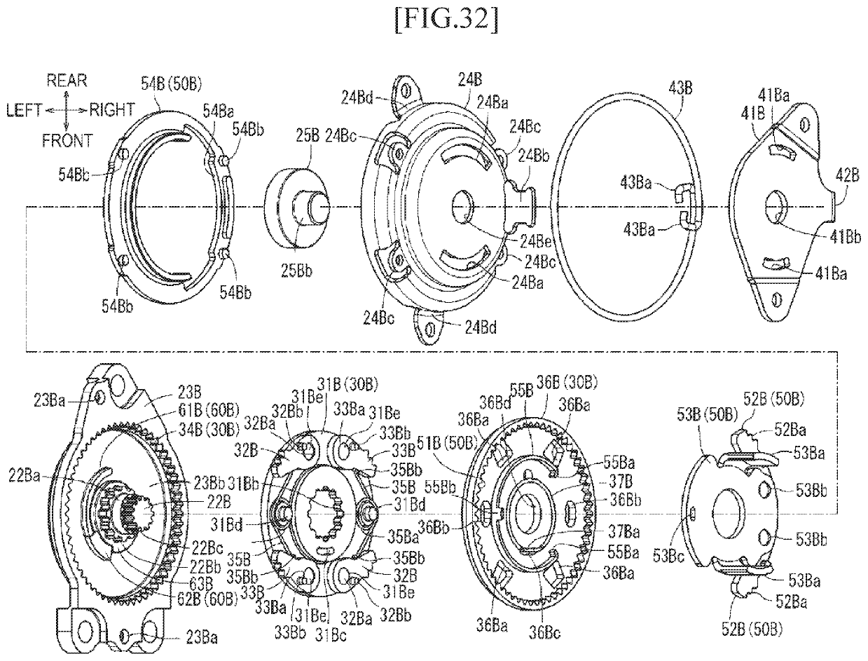

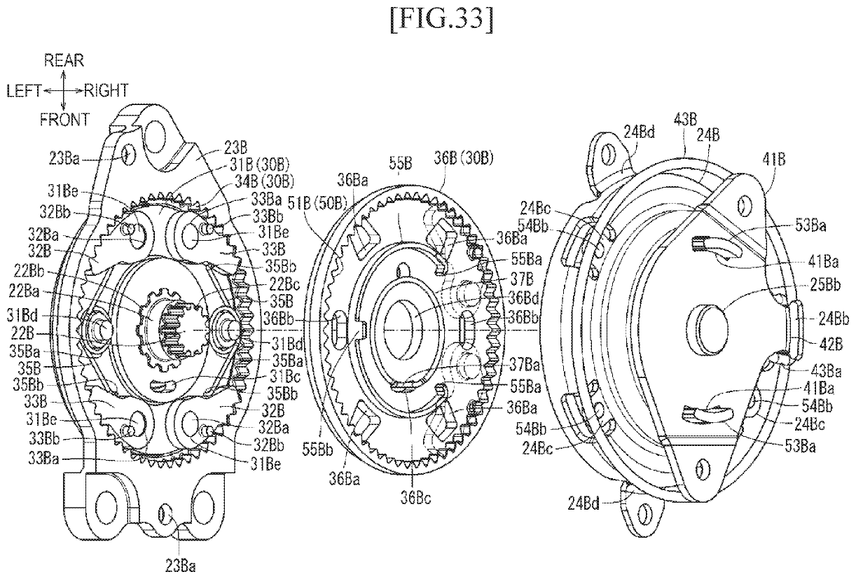

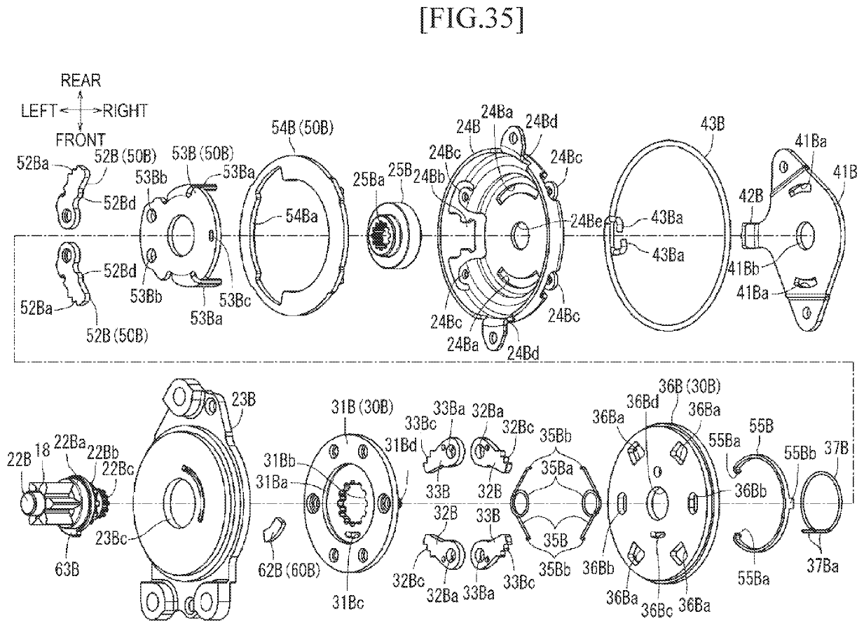

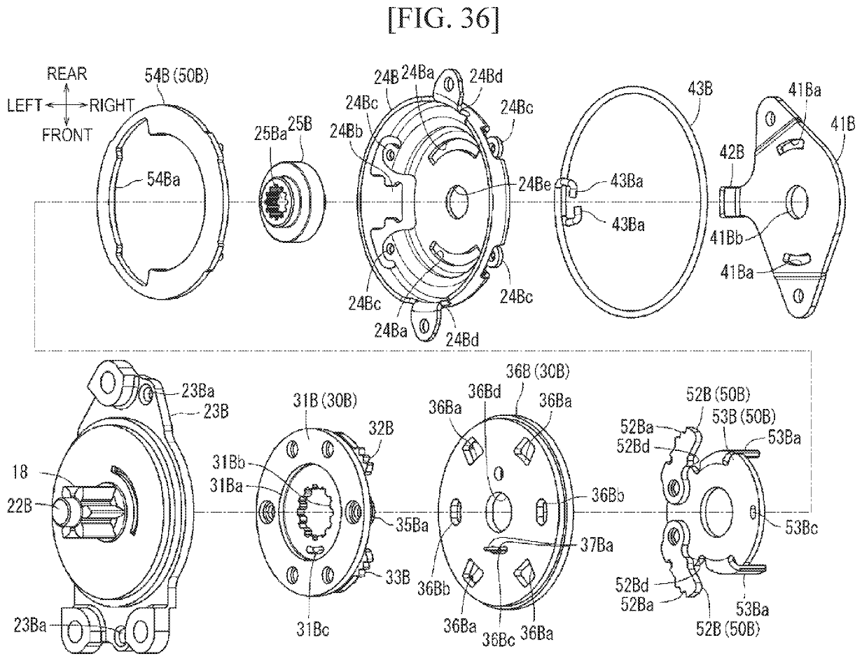

Hereinafter, a configuration of a rotation control device 21B of a lifter device according to a third embodiment of the present invention (lock mechanism 30B) will be described. FIGS. 26 to 28 show a state in which the rotation control device 21B is detached from the seat cushion 2. Hereinafter, the configuration of the rotation control device 21B is described with reference to FIGS. 26 to 37.

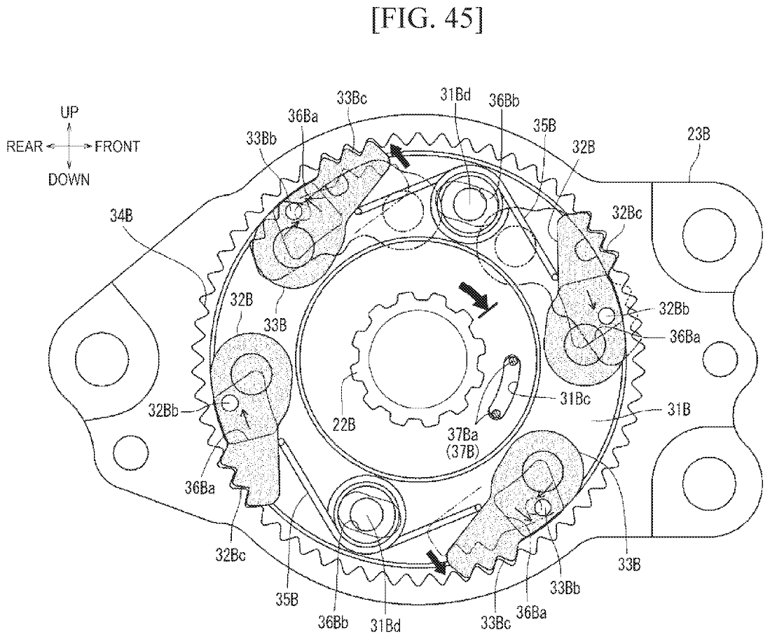

The rotation control device 21B is assembled such that the pinion gear 18 protrudes from a left side surface of a support member 23B through a rotation shaft 22B in a center hole 23Bc of the support member 23B, which is a base member. The support member 23B is fixed to the side frame 13 in a state in which the pinion gear 18 passes through the through-hole 13a (see FIG. 45) of the side frame 13.

A right side surface of the support member 23B is formed into a circular container shape as a whole by stamping a guide recess 23Bb on a left side so as to accommodate a lock plate 31B of the lock mechanism 30B. Inner teeth 34B are formed on an inner circumferential surface of the guide recess 23Bb to mesh with pawls 32B, 33B, which will be described below. A spline hole 31Bb is formed at a center of the lock plate 31B, and is engaged with a spline 22Bb of the rotation shaft 22B. Therefore, the lock plate 31B is rotated in synchronization with the rotation shaft 22B.

On an outer circumferential part of a right side surface of the lock plate 31B, each one protrusion 31Bd is formed to protrude dispersedly on an upper side and a lower side, and each two protrusions 31 Be are formed to protrude dispersedly on a front side and a rear side. The protrusions 31 Be are fitted into through-holes 32Ba, 33Ba of the pawls 32B, 33B, and the pawls 32B, 33B are swingable about the protrusions 31 Be. Winding parts 35Ba of torsion springs 35B are fitted to the protrusions 31Bd, and each end part 35Bb of the torsion springs 35B is engaged with each of the pawls 32B, 33B, and biases each of the pawls 32B, 33B toward an outer circumferential side of the lock plate 31B. For this reason, engagement end parts 32Bc, 33Bc of the pawls 32B, 33B are always meshed with the inner teeth 34B of the support member 23B.

A state in which the lock mechanism 30B is assembled to the support member 23B as described above is shown in FIG. 33.

<Configuration of Rotation Control Device 21B (Rotation Drive Mechanism 50B)>

A plate-shaped input member 41B that is coupled to the operation handle 20 to rotate the operation handle 20 is provided on a right side surface of a cover 24B formed in a container shape that bulges rightward as a whole. In a center hole 41Bb of the input member 41B, a caulk end 25Bb of a caulk pin 25B is inserted through a through-hole 24Be of the cover 248 and is fixed by caulking. The cover 24B and the input member 41B are slidably coupled to each other by the caulk pin 25B. An engagement piece 42B is bent leftward on an upper portion of the input member 41B. The engagement piece 42B is aligned to an inner circumferential side of an engagement piece 24Bb protruding on a right side of the cover 24B. An end part 43Ba of a torsion spring 43B is disposed so as to wrap around the engagement pieces 42B, 24Bb. For this reason, when the input member 41B is rotated by the operation handle 20, the engagement piece 42B moves away from the engagement piece 24Bb in the circumferential direction. When the rotation operation is released, the engagement piece 42B and the engagement piece 24Bb are driven by a biasing force of the torsion spring 43B to overlap each other in the circumferential direction, and the input member 41B is returned to a position before the rotation operation.

A coupling member 53B and a cam member 54B are provided on a left side of the cover 24B so as to be accommodated in the container-shaped cover 24B. The cover 24B sandwiches these components with the lock plate 31B and a rotation transmission plate 36B and is fixed to the support member 23B. At this time, leg parts 24Bd of the cover 24B are fixed to through-holes 23Ba of the support member 238 by rivets (not shown).

The cam member 54B is formed in a substantially ring shape, and includes four pins 54Bb on a right side surface. A cam protrusion 54Ba protrudes above an inner circumference of the ring shape. In the cam member 548, each pin 54Bb is fitted into a through-hole of a protruding piece 24Bc of the cover 24B, and is fixed to an inner side of the cover 24B.

The coupling member 53B includes arms 53Ba extending rightward on front and rear parts. Each arm 53Ba passes through an opening 24Ba of the cover 24B and penetrates a through-hole 41Ba of the input member 41B. For this reason, the coupling member 53B is capable of being rotated together with the input member 41B. A pair of feed claws 52B is swingably coupled to a left side surface of the coupling member 53B by fitting hinge parts 52Bb of the feed claws 52B into through-holes 53Bb of the coupling member 53B.

<Configuration of Rotation Control Device 21B (Rotation Transmission Plate 36B)>

The rotation transmission plate 36B is provided on the left side of the coupling member 53B. The rotation transmission plate 36B is interposed between the coupling member 53B and the lock plate 31B. Four substantially rectangular engagement holes 36Ba are formed corresponding to the pawls 32B, 33B on a surface of the rotation transmission plate 36B. Pins 32b, 33Bb of the pawls 32B, 33B are engageably inserted into the engagement holes 36Ba. Two elliptical engagement holes 36Bb are formed corresponding to the protrusions 31Bd on the surface of the rotation transmission plate 36B. Each protrusion 31Bd is engageably inserted into each of the engagement holes 36Bb.

Further, on a right side surface of the rotation transmission plate 36B, torsion springs 37B, 55B are provided around a center hole 36Bd. An end part 37Ba of the torsion spring 37B is bent leftward and is engageably inserted into a long hole 36Bc of the rotation transmission plate 36B and a long hole 31Bc of the lock plate 31B. The torsion spring 37B maintains a rotation angle of the rotation transmission plate 36B at the neutral position with respect to the lock plate 31B by a biasing force of the torsion spring 37B. Meanwhile, an end part 55Ba of the torsion spring 55B biases a protrusion 52Bd of the feed claw 52B and presses each feed claw 52B toward the outer circumferential side. A protrusion 55Bb protruding rightward is formed at a central part of the torsion spring 55B. The protrusion 55Bb is inserted into and engaged with an engagement hole 53Bc formed at a central part of a lower end of the coupling member 53B. For this reason, the protrusion 52Bd of the feed claw 52B is always pressed against the end part 55Ba of the torsion spring 55B. An engagement end part 52Ba is engaged with inner teeth 51B of the rotation transmission plate 36B.

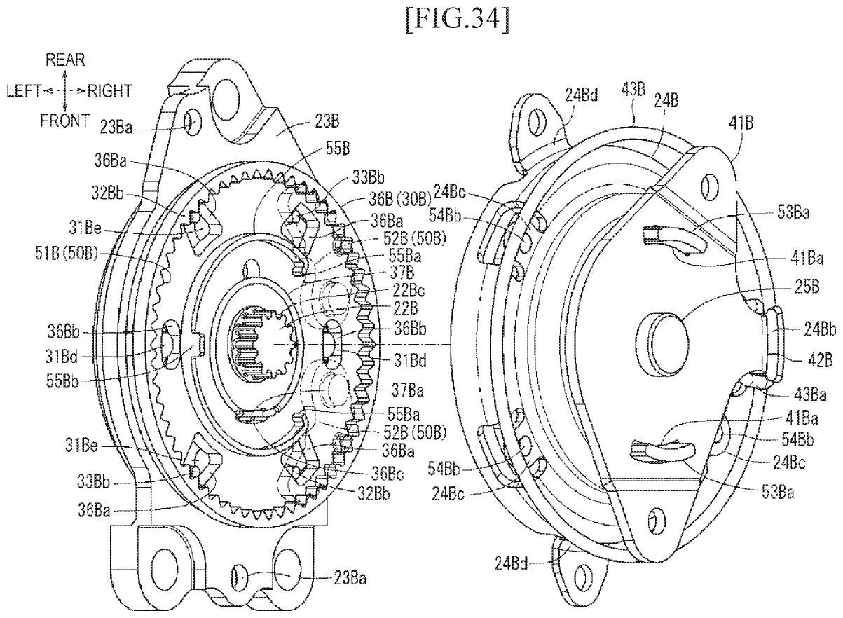

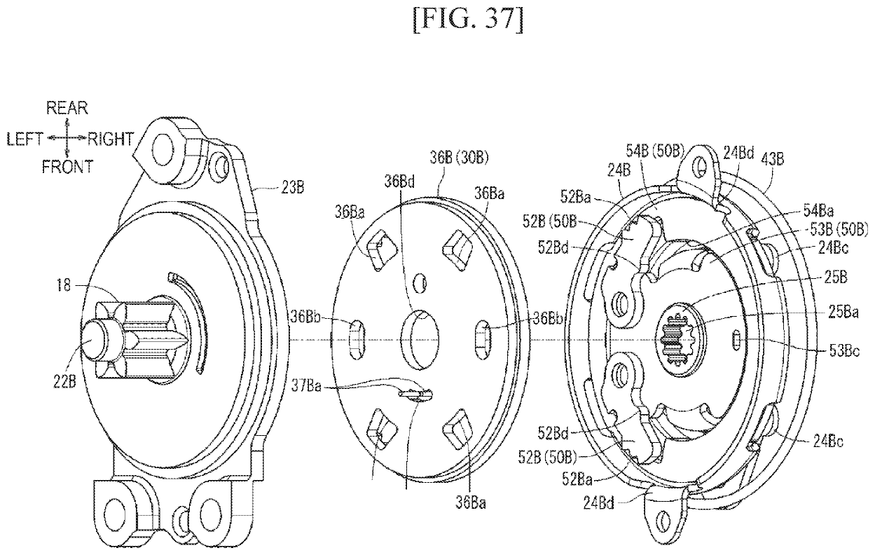

As described above, a state in which the input member 41B and a rotation drive mechanism 50B (the coupling member 53B, the cam member 54B, the feed claw 52B, the inner teeth 51B of the rotation transmission plate 36B, and the torsion spring 55B) are assembled to the cover 24B is shown in FIGS. 33 and 37. A state in which the rotation transmission plate 36B is assembled on the lock plate 31B is shown in FIG. 34. FIGS. 33 and 34 do not show an assembly procedure of the rotation control device 21B, but the rotation control device 21B is assembled by finally fitting a spline 22Bc of the rotation shaft 22B to a spline hole 25Ba of the caulk pin 25B and further fixing the cover 24B to the support member 23B.

<Configuration of Rotation Control Device 21 (Stopper 60B)>

An outer circumferential surface 22Ba is formed between the pinion gear 18 of the rotation shaft 22B and the spline 22Bb. A rotation shaft-side protrusion 63B is formed at a specific angular position of the outer circumferential surface 22Ba and protrudes in the radial direction. In a state where the rotation shaft 22B is inserted into the center hole 23Bc of the support member 23B, the rotation shaft-side protrusion 63B is positioned so as to be exposed on a right side surface of the guide recess 23Bb of the support member 23B.

An arc-shaped support member-side protrusion 61B is formed by stamping on the right side surface of the guide recess 23Bb of the support member 23B. Meanwhile, the lock plate 31B is stamped to form a sliding surface part 31Ba concentric with the spline hole 31Bb around the spline hole 31 Bb of the lock plate 31B. When the lock plate 31B is rotated with respect to the support member 23B, an outer circumference of the support member-side protrusion 61B slides on an inner circumference of the sliding surface part 31Ba. An engagement piece 62B is disposed so as to slide in a gap between the inner circumference of the sliding surface part 31Ba and the outer circumferential surface 22Ba of the rotation shaft 22B.

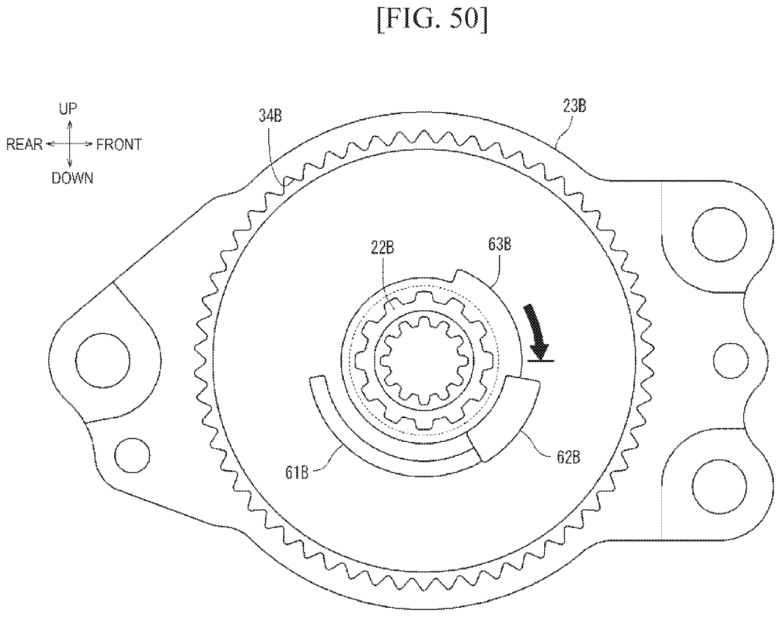

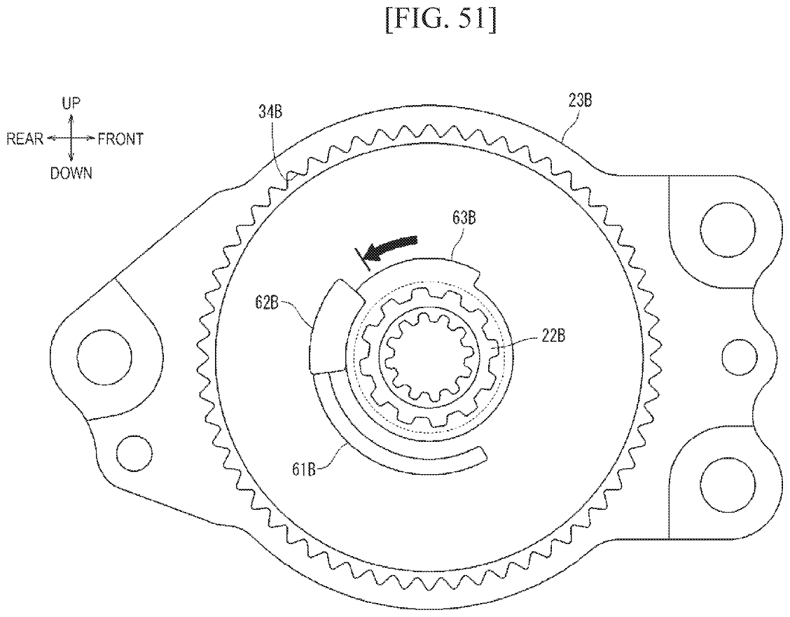

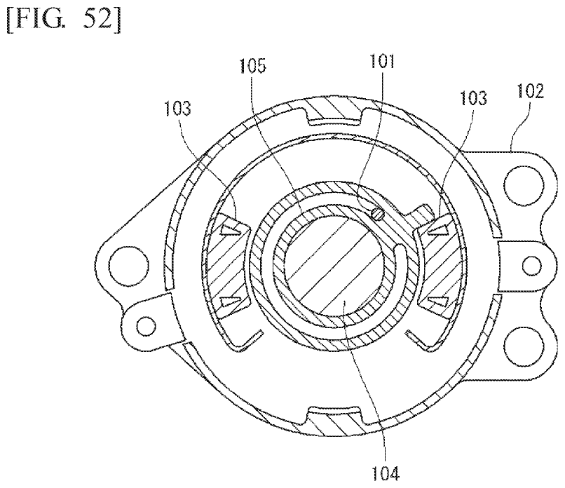

Therefore, when the rotation shaft 22B is rotated in the lowering direction by an operation of the rotation control device 21B and reaches the lower limit position, as shown in FIG. 50, the rotation shaft-side protrusion 63B abuts against an end part of the support member-side protrusion 61B with the engagement piece 62B interposed therebetween, and further rotation of the rotation shaft 22B is stopped. Therefore, when the rotation shaft 22B is rotated in the lifting direction and reaches the upper limit position, as shown in FIG. 51, the rotation shaft-side protrusion 63B abuts against an opposite side end part of the support member-side protrusion 61B with the engagement piece 62B interposed therebetween, and the further rotation of the rotation shaft 22B is stopped.

<Operation of Rotation Control Device 21B (Operation Handle 20 Not Operated)>

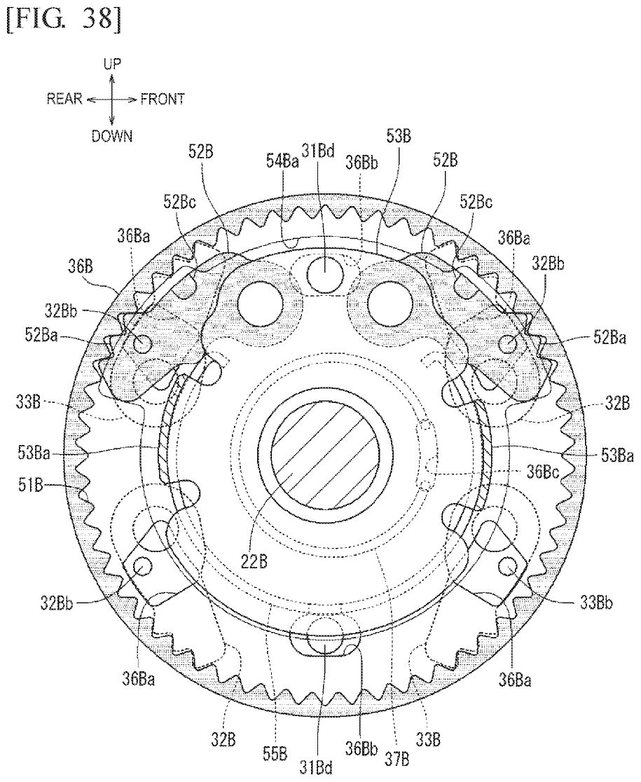

Hereinafter, the height adjustment operation of the seat cushion 2 performed by the rotation control device 21B is described with reference to FIGS. 38 to 49.

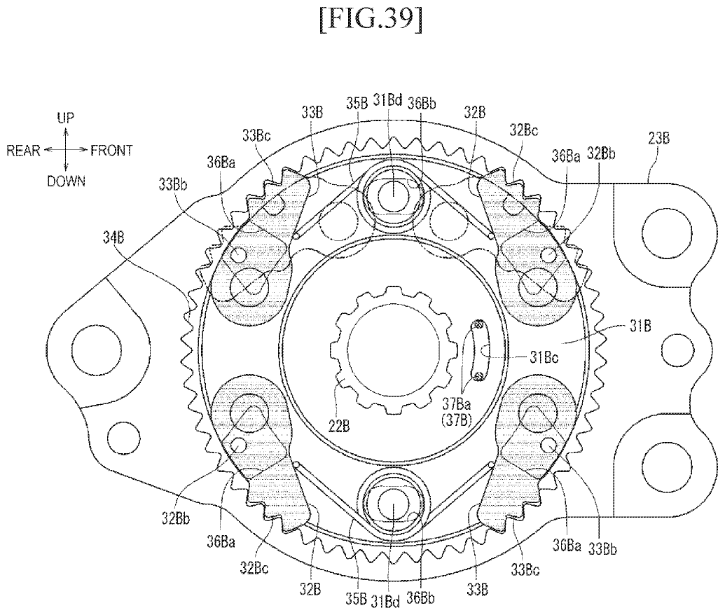

FIGS. 38 and 39 show a state of a neutral position in which the operation handle 20 is not operated, and the input member 41B and the coupling member 53B are not rotated. At this time, as shown in FIG. 38, the engagement end part 52Ba is engaged with the inner teeth 51B of the rotation transmission plate 36B by the biasing of the torsion spring 55B. As shown in FIG. 39, the engagement end parts 32Bc, 33Bc of the pawls 32B, 33B of the lock mechanism 30B are engaged with the inner teeth 34B of the support member 23B by the biasing of the torsion springs 35B. Therefore, the lock mechanism 30B is in a lock state, the lock plate 31B is not rotated, and the height of the seat 1 is not changed on the lifting side and the lowering side.

<Operation of Rotation Control Device 21B (Push Down Operation Handle 20)>

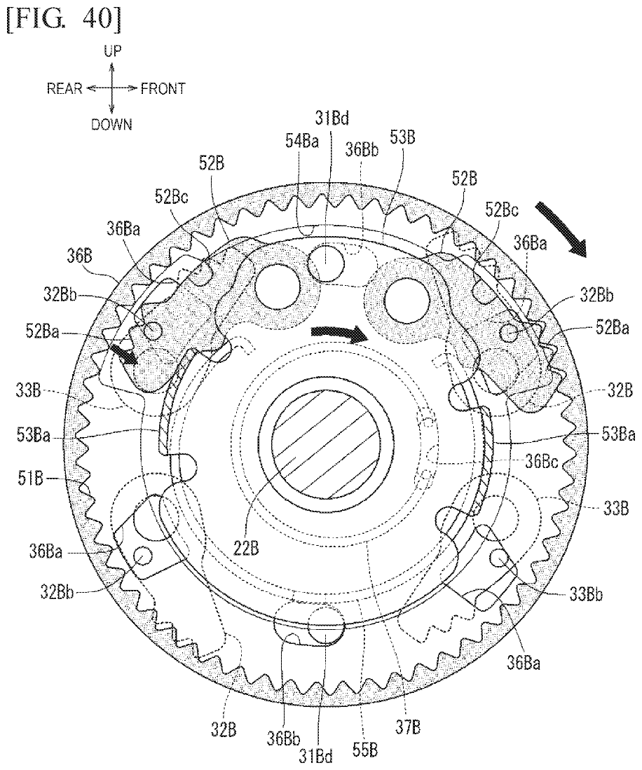

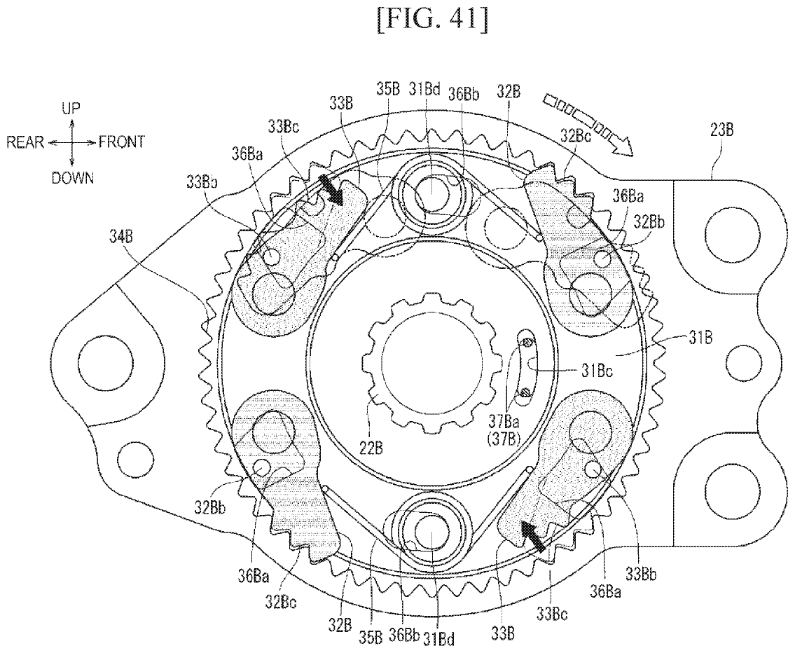

FIGS. 40 and 41 show a state in which the operation handle 20 is pushed down from the neutral position to the middle position. At this time, as shown in FIG. 40, the coupling member 53B is rotated by rotation of the input member 41B in an arrow direction. As a result, the feed claws 52B are moved in the same direction. Therefore, the engagement end part 52Ba of the front feed claw 52B transmits a force to the inner teeth 51B of the rotation transmission plate 36B to rotate the rotation transmission plate 36B in the arrow direction. At this time, the engagement end part 52Ba of the rear feed claw 52B is not engaged with the inner teeth 51B of the rotation transmission plate 36B. That is, in this state, teeth of the engagement end part 52Ba receive a load in a normal direction of teeth of the inner teeth 51B and are moved in a direction to release meshing. Further, with rotation of the rotation transmission plate 36B, a pin 52Bc of the rear feed claw 52B rides on the cam protrusion 54Ba of the cam member 54B, and the engagement end part 52Ba is separated from the inner teeth 51B.

When the rotation transmission plate 36B is rotated in this manner, as shown in FIG. 41, the engagement holes 36Ba of the rotation transmission plate 36B are engaged with pins 33Bb of pawls 33B, and the engagement end parts 33Bc of the pawls 33B are separated from the inner teeth 34B of the support member 23B. That is, the lock state of the lock plate 31B in the lowering direction is released. Thereafter, when the protrusion 31Bd of the lock plate 31B is engaged with the engagement hole 36Bb, the rotation of the rotation transmission plate 36B can be transmitted to the lock plate 31B.

<Operation of Rotation Control Device 21B (Operation Handle 20 Operated by Full Stroke)>

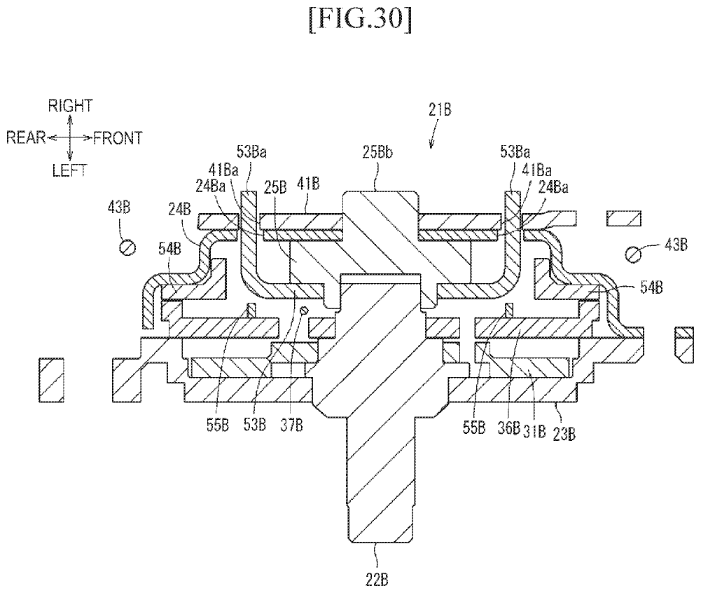

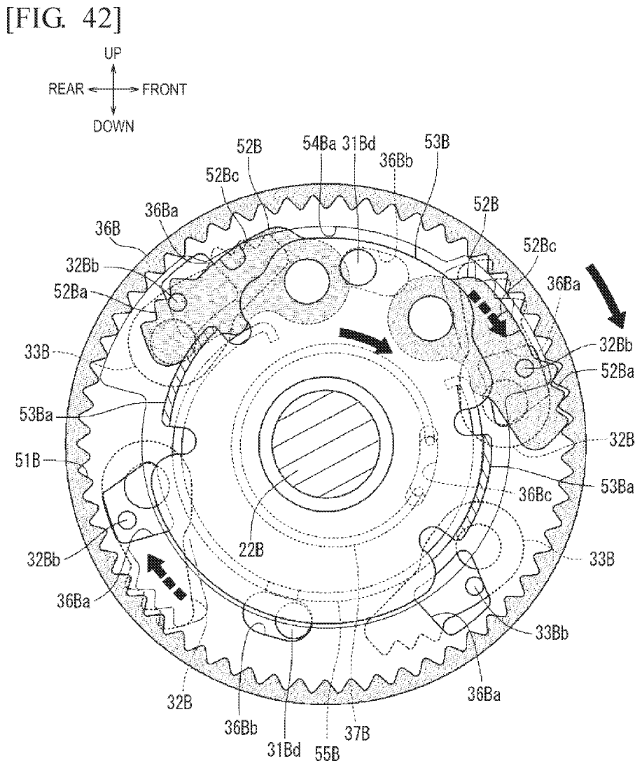

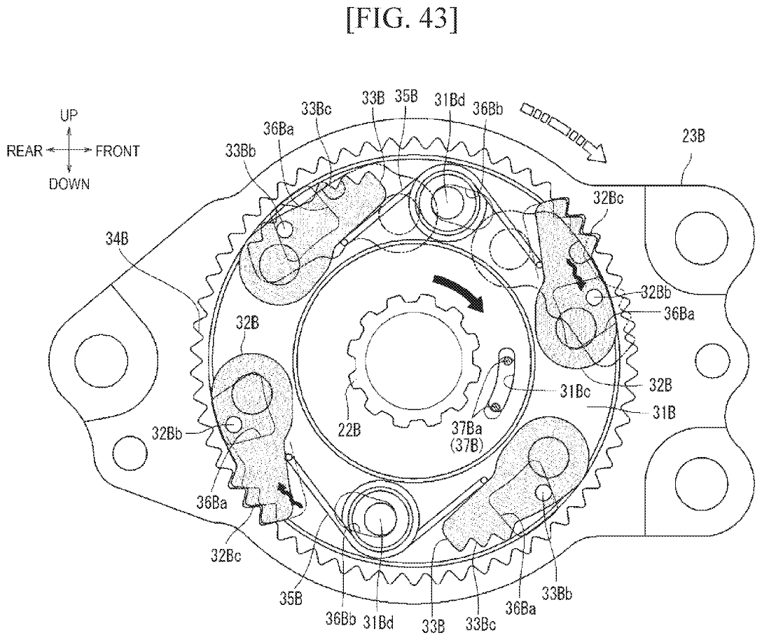

FIGS. 42 and 43 show a state in which the operation handle 20 is pushed down from the neutral position to the full stroke position. The full stroke position is determined by abutting of the arm 53Ba of the coupling member 53B against a circumferential end part of the opening 24Ba of the cover 24B (see FIGS. 30, 32 and 33). At this time, as shown in FIG. 42, the rotation of the coupling member 53B and feed claws 52B proceeds, and a rotation angle of the rotation transmission plate 36B is increased by the front feed claw 52B as compared with the state of FIG. 40.

When the rotation angle of the rotation transmission plate 36B is increased in this manner, as shown in FIG. 43 by a large black arrow, the rotation of the rotation transmission plate 36B is transmitted to the lock plate 31B, the lock plate 31B is rotated, and the rotation shaft 22B is rotated. As a result, the pinion gear 18 is rotated, and the seat cushion 2 is lowered. At this time, the engagement end parts 32Bc of the pawls 32B are not engaged with the inner teeth 34B of the support member 23B. That is, in this state, teeth of the engagement end parts 32Bc receive a load in a normal direction of teeth of the inner teeth 34B and are moved in a direction to release meshing. Therefore, when the lock plate 31B rotates, the engagement end parts 32Bc of the pawls 32B slide on the inner teeth 34B of the support member 23B. Movement of the pawls 32B at this time is shown by solid lines and virtual lines. The movement is also shown by wave arrows.

<Operation of Rotation Control Device 21B (Influence of Gravity on Seat 1)>

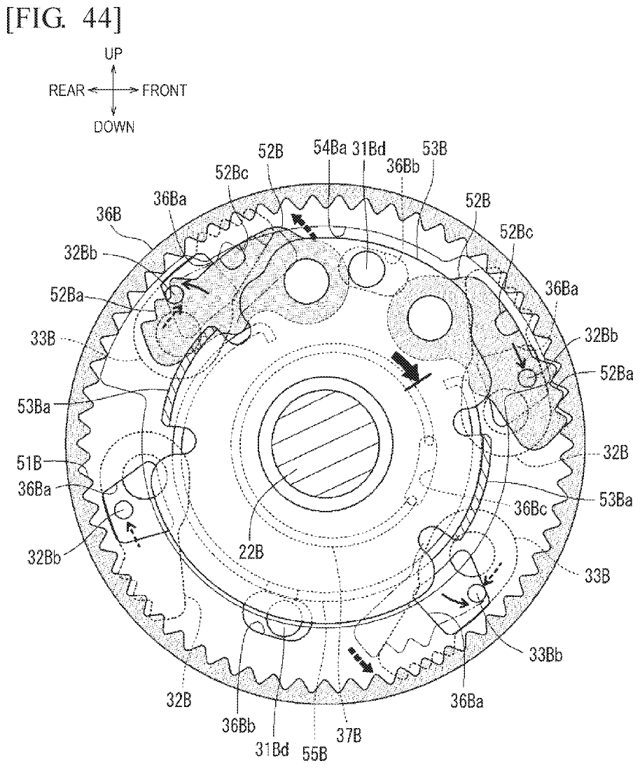

FIGS. 44 and 55 show a state in which the rotation of the pinion gear 18 in the seat lowering direction due to gravity applied to the seat cushion 2 exceeds the rotation of the pinion gear 18 in the seat lowering direction due to the above-described push-down operation of the operation handle 20. That is, a state in which a push-down operation force of the operation handle 20 is weakened is shown. At this time, since the rotation of the rotation transmission plate 36B is continued by the feed claws 52B, a state of the feed claws 52B shown in FIG. 44 is the same as the state of FIG. 42. Meanwhile, the lock plate 31B is not rotated by the rotation transmission plate 36B, but is rotated by the rotation shaft 22B. For this reason, as shown in FIG. 45, a swinging state of the pawls 33B is released by the engagement holes 36Ba, and the pawls 33B lock the rotation of the lock plate 31B in the lowering direction. Therefore, the seat cushion 2 is prevented from being lowered by the gravity applied to the seat cushion 2 during the push-down operation of the operation handle 20. In this state, it is desirable to prevent the rotation of the rotation shaft 22B caused by the gravity of the seat 1 by applying a certain degree of brake to the rotation of the rotation shaft 22B, so as to prevent the problem that an operation of locking the rotation of the lock plate 31B in the lowering direction is delayed and the seat cushion 2 is lowered by the gravity.

<Operation of Rotation Control Device 21B (Push-Down of Operation Handle 20 Stopped)>

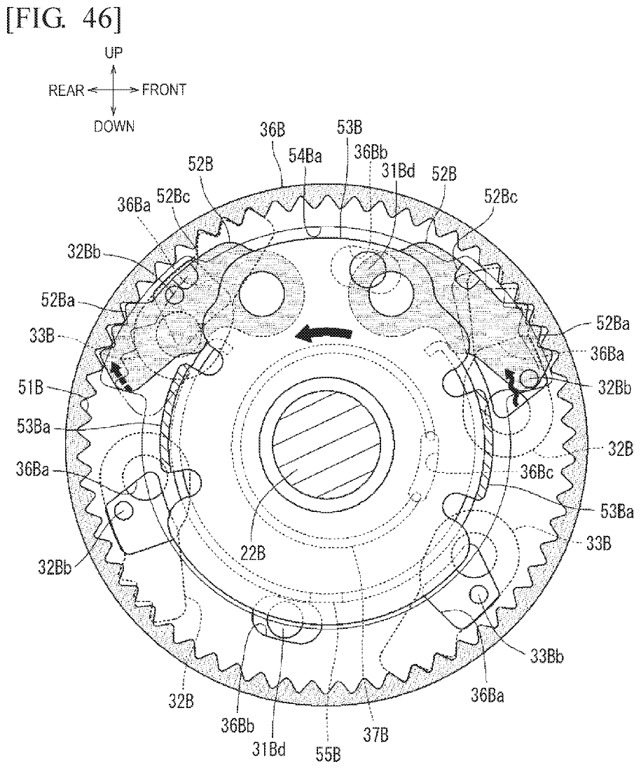

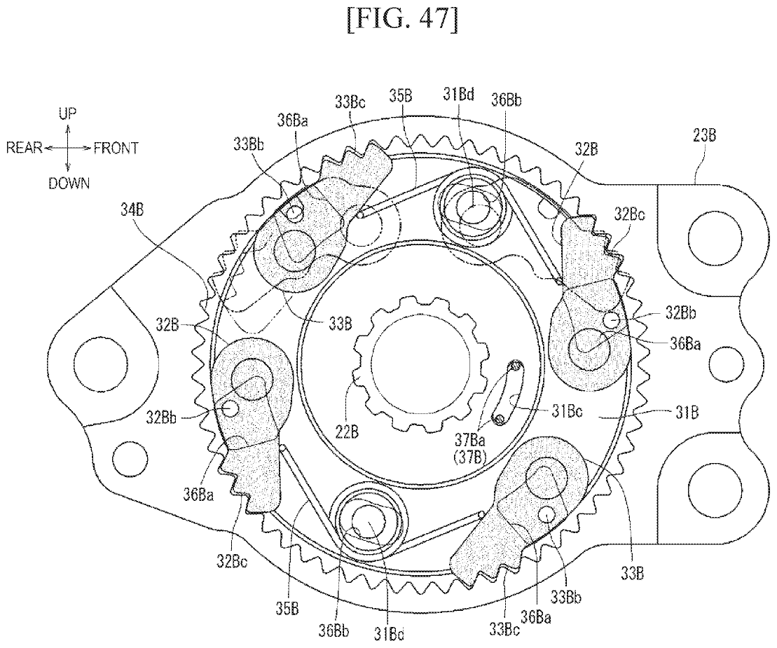

FIGS. 46 and 47 show a state in which the push-down operation of the operation handle 20 is stopped and the operation handle 20 is returned to the neutral position. At this time, the input member 41B is returned to the neutral position by a biasing force of the torsion spring 43B, and the coupling member 53B is also returned to the neutral position in synchronization. For this reason, the coupling member 53B is rotated as shown by arrows in FIG. 46. Until the coupling member 53B is returned to the neutral position, the rear feed claw 52B is in a state in which the pin 52Bc rides on the cam protrusion 54Ba of the cam member 54B. When the coupling member 53B returns to the neutral position, as shown in FIG. 46, the engagement end part 52Ba of the rear feed claw 52B returns to a state in which the engagement end part 52Ba meshes with the inner teeth 51B of the rotation transmission plate 36B. Meanwhile, the engagement end part 52Ba of the front feed claw 52B slides on the inner teeth 51B of the rotation transmission plate 36B until the coupling member 53B is returned to the neutral position.

When the push-down operation of the operation handle 20 is stopped, as described above, since rotation drive of the feed claw 52B toward the rotation transmission plate 36B is released, the rotation transmission plate 36B is returned by a biasing force of the torsion spring 37B to an initial position with respect to the lock plate 31B. For this reason, as shown in FIG. 47, the engagement end parts 32Bc, 33Bc of the pawls 32B, 33B are engaged with the inner teeth 34B of the support member 23B, and the lock plate 31B is locked at that position. Therefore, the rotation of the pinion gear 18 is also stopped, and the height of the seat cushion 2 is maintained at the position operated so far.

<Operation of Rotation Control Device 21B (Pull Up Operation Handle 20)>

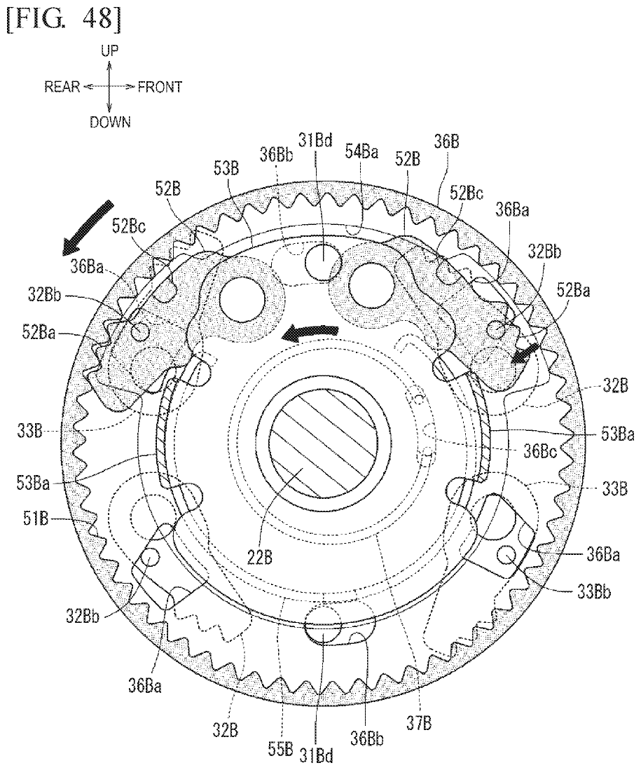

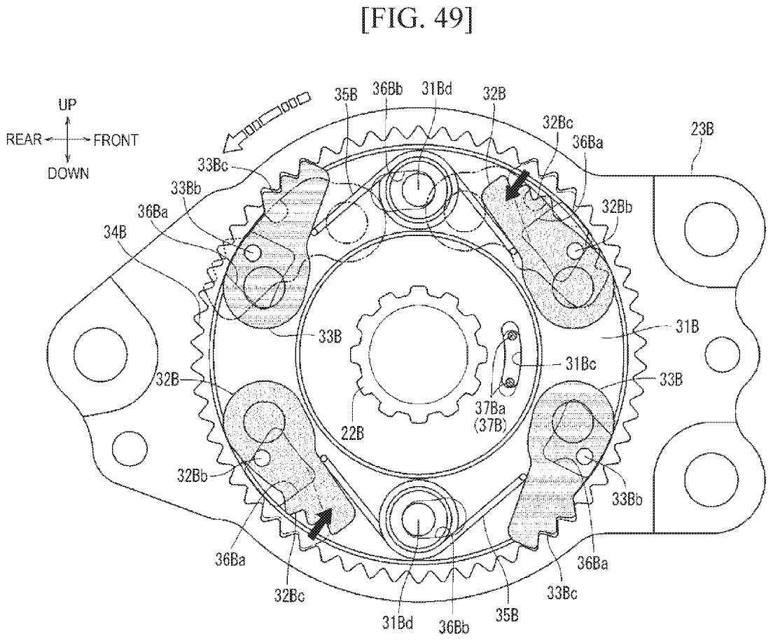

FIGS. 48 and 49 show a state in which the operation handle 20 is pulled up from the neutral position to the middle position. At this time, as shown in FIG. 48, the coupling member 53B is rotated by rotation of the input member 41B in an arrow direction. As a result, the feed claws 52B are moved in the same direction. Therefore, the engagement end part 52Ba of the rear feed claw 52B transmits a force to the inner teeth 51B of the rotation transmission plate 36B to rotate the rotation transmission plate 36B in the same direction. At this time, the engagement end part 52Ba of the front feed claw 52B is not engaged with the inner teeth 51B of the rotation transmission plate 36B. That is, in this state, teeth of the engagement end part 52Ba receive a load in a normal direction of teeth of the inner teeth 51B and are moved in a direction to release meshing. Further, with the rotation of the rotation transmission plate 36B, the pin 52Bc of the front feed claw 52B rides on the cam protrusion 54Ba of the cam member 54B, and the engagement end part 52Ba is separated from the inner teeth 51B.

When the rotation transmission plate 36B is rotated in this manner, as shown in FIG. 49, the engagement holes 36Ba of the rotation transmission plate 36B are engaged with pins 32Bb of pawls 32B, and the engagement end parts 32Bc of the pawls 32B are separated from the inner teeth 34B of the support member 23B. That is, the lock state of the lock plate 31B in the lifting direction is released. Thereafter, when the protrusion 31Bd of the lock plate 31B is engaged with the engagement hole 36Bb, the rotation of the rotation transmission plate 36B is transmitted to the lock plate 31B. For this reason, as shown by arrows in FIG. 49, the lock plate 31B is rotated to rotate the rotation shaft 22B. As a result, the pinion gear 18 is rotated and the seat 1 is lifted. At this time, the engagement end parts 33Bc of the pawls 33B are not engaged with the inner teeth 34B of the support member 23B. That is, in this state, teeth of the engagement end parts 33Bc receive a load in the normal direction of the teeth of the inner teeth 34B and are moved in a direction to release meshing. Therefore, when the lock plate 31B rotates, the engagement end parts 33Bc of the pawls 33B slide on the inner teeth 34B of the support member 23B.

<Operation of Rotation Control Device 21 (Summary)>

As described above, when the operation handle 20 is pushed down, the seat 1 is lowered by an amount corresponding to the operation. By repeating the push-down operation, the seat 1 can be adjusted to a desired height. Conversely, when the operation handle 20 is pulled up, the seat 1 is similarly lifted by an amount corresponding to the operation. By repeating the pull-up operation, the seat 1 can be adjusted to a desired height.

When the seat 1 reaches the lower limit position or the upper limit position due to the above operation, the further rotation of the rotation shaft 22B is stopped as shown in FIG. 50 or FIG. 51.

<Effect of Third Embodiment>

According to the third embodiment, the rotation shaft-side protrusion 63B protrudes in the radial direction from the outer circumferential surface of the rotation shaft 22B, and engages with the support member-side protrusion 61B via the engagement piece 62B at the two end parts in the rotation direction of the rotation shaft-side protrusion 63B. Moreover, the rotation shaft-side protrusion 63B and the support member-side protrusion 61B are not engaged with each other in the rotation direction, but engaged with the engagement piece 62B interposed between the end parts facing each other in the rotation direction. An angle between the upper limit position and the lower limit position where the rotation shaft-side protrusion 63B and the support member-side protrusion 61B engage with each other with the engagement piece 62B interposed therebetween can be larger than 360 degrees. For this reason, strength of the rotation shaft-side protrusion 63B can be easily secured by securing a size of the rotation shaft-side protrusion 63B in the rotation direction. As a result, the strength of the stopper can be ensured without enlarging the rotation shaft-side protrusion 63B in the radial direction. The lock plate 31B is used to form the sliding surface part 31Ba. For this reason, the sliding surface part 31Ba can be formed without increasing the number of components, and the device can be downsized.

### Other Embodiments

Although specific embodiments have been described above, the present invention is not limited to those appearances and configurations, and modifications, additions and deletions can be made thereto. For example, although in the above embodiments the present invention is applied to the seat of an automobile, the present invention may also be applied to a seat mounted on an airplane, a ship, a train or the like, or a seat provided in a cinema or the like.

This application is based on Japanese Patent Application No. 2017-103697 filed on May 25, 2017, Japanese Patent Application No. 2017-214655 filed on Nov. 7, 2017, and Japanese Patent Application No. 2018-086130 filed on Apr. 27, 2018, the contents of which are incorporated herein by reference.

### INDUSTRIAL APPLICABILITY

The lifter device of the present invention is useful, for example, in an automobile seat in which height adjustment can be performed by operating an operation handle.

### REFERENCE SIGNS LIST

1 Automobile seat (seat)
2 Seat cushion
3 Seat back
4 Floor
5 Lower rail
6 Upper rail
7 Bracket
8 Seat slide device
10 Lifter device
11 Link member
11a Front link
11b Rear link
12 Link mechanism
13 Side frame
13a Through-hole
14 Base member
16 Sector gear (input gear)
17 Torque rod
18 Pinion gear
19 Damper
20 Operation handle
21, 21A, 21B Rotation control device
22, 22B Rotation shaft
22a Hexagonal part
22b Quadrangular part
22c, 22Ac Outer circumferential surface part (small-diameter side outer circumferential surface part)
23, 23A Support member
23a Through-hole
23b Rivet
23c Guide recess
23d, 23Ad Sliding surface part
24 Cover
24a, 24b Opening
24c Engagement piece
24d Leg part
30 Lock mechanism
31 Ratchet (large-diameter side outer circumferential surface part)
32 Main pawl (pawl)
32a Engagement protrusion
33, 33A, 35, 35A Guide part
34 Sub-pawl (pawl)
34a Engagement protrusion
36 Ring spring
37 Pawl operation member
37a Protrusion
37b Neck part
37c Guide groove
37d, 37e Engagement protrusion
37f Guide groove
37g, 37h Engagement protrusion
38 Protrusion
41 Input member
41a Coupling part
42 Coupling member
42a Engagement part
42b Spring
50 Rotation drive mechanism
51 Ratchet
52 Drive lever
52a Engagement end part
52b Engagement part
61 Intermediate member
61a Arc wall
62 Ring spring
62a Extending end part
70 Stopper
71, 71A Rotation shaft-side protrusion
72 Ring
73, 73A Support member-side protrusion
73a Engagement surface part
73b Guide surface part
73c First enlarged diameter surface part
73d Second enlarged diameter surface part
73e Third enlarged diameter surface part
73f Fourth enlarged diameter surface part
74, 74A Engagement member
74a First engagement part
74b Second engagement part
21B Rotation control device
22B Rotation shaft
22Ba Outer circumferential surface
22Bb, 22bc Spline
23B Support member
23Ba Through-hole
23Bb Guide recess
23Bc Center hole
24B Cover
24Ba Opening
24Bb Engagement piece
24Bc Protruding piece
24Bd Leg part
24Be Through-hole
25B Caulk pin
25Ba Spline hole
25Bb Caulk end part
30B Lock mechanism
31B Lock plate
31Ba Sliding surface part
31Bb Spline hole
31Bc Long hole
31Bd, 31 Be Protrusion
32B, 33B Pawl
32Ba, 33Ba Through-hole
32Bb, 33Bb Pin
32Bc, 33Bc Engagement end part
34B Inner teeth
35B Torsion spring
35Ba Winding part
35Bb End part
36B Rotation transmission plate
36Ba Engagement hole
36Bb Engagement hole
36Bc Long hole
36Bd Center hole
37B Torsion spring
37Ba End part
41B Input member
41Ba Through-hole
41Bb Center hole
42B Engagement piece
43B Torsion spring
43Ba End part
50B Rotation drive mechanism
51B Inner teeth
52B Feed claw
52Ba Engagement end part
52Bb Hinge part
52Bc Pin
52Bd Protrusion
53B Coupling member
53Ba Arm
53Bb Through-hole
53Bc Engagement hole
54B Cam member
54Ba Cam protrusion
54Bb Pin
55B Torsion spring
55Ba End part
55Bb Protrusion
60B Stopper
61B Support member-side protrusion
62B Engagement piece
63B Rotation shaft-side protrusion

1. A lifter device comprising:
a pinion gear configured to mesh with an input gear of a link mechanism that lifts and lowers a seat; and
a rotation control device configured to control rotation of the pinion gear,
wherein the rotation control device includes:
a rotation shaft configured to rotate in synchronization with the pinion gear;
a support member rotatably supporting the rotation shaft;
a rotation drive mechanism configured to rotate the rotation shaft so as to correspond to an operation of an operation handle for lifting and lowering the seat;
a lock mechanism configured to lock the rotation of the rotation shaft at an operation end position of the operation handle; and
a stopper configured to restrict the rotation of the rotation shaft at an upper limit position or a lower limit position that restricts the lifting and lowering of the seat,
wherein the stopper includes:
a rotation shaft-side protrusion provided to an outer circumferential surface of the rotation shaft;
an engagement member slidably provided to the outer circumferential surface of the rotation shaft, and engaged with the rotation shaft-side protrusion in a circumferential direction of the rotation shaft when the engagement member is at a predetermined engagement position in a rotation direction of the rotation shaft; and
a support member-side protrusion provided to the support member, and engaged with the engagement member in the circumferential direction when the engagement member is at the engagement position, and
wherein, when the seat is at the upper limit position or the lower limit position, the rotation of the rotation shaft is restricted by becoming a state where the engagement member is at the engagement position and the engagement member is interposed between the rotation shaft-side protrusion and the support member-side protrusion.

2. The lifter device according to claim 1,
wherein the rotation drive mechanism is provided to the rotation shaft, configured to rotationally drive the rotation shaft in a lifting direction when the operation handle is operated to lift the seat, and configured to bring the rotation shaft into a freely rotatable state without rotationally driving the rotation shaft when the operation handle is operated to lower the seat,
wherein the lock mechanism is provided to the rotation shaft, configured to lock the rotation of the rotation shaft at the operation end position of the operation handle when the operation handle is operated to lift the seat, and configured to bring the rotation shaft into the freely rotatable state without locking the rotation of the rotation shaft when the operation handle is operated to lower the seat,
wherein the rotation shaft-side protrusion is provided across an outer circumferential surface of a small-diameter side outer circumferential surface part and an end surface of a large-diameter side outer circumferential surface part adjacent to each other in a step part, the step part being formed by making outer diameters of the outer circumferential surface of the rotation shaft different, and the rotation shaft-side protrusion protruding from each of the surfaces,
wherein the engagement member is slidably supported on the outer circumferential surface of the small-diameter side outer circumferential surface part, and configured to engage with the rotation shaft-side protrusion in the rotation direction of the rotation shaft, and wherein the support member-side protrusion is configured such that a sliding surface part of the support member is concentric with the outer circumferential surface of the small-diameter side outer circumferential surface part, a portion of the sliding surface part protrudes toward the small-diameter side outer circumferential surface part and is configured to engage with the engagement member in the rotation direction of the rotation shaft, the sliding surface part facing the small-diameter side outer circumferential surface part so that the engagement member is slidably interposed between the sliding surface part of the support member and the outer circumferential surface of the small-diameter side outer circumferential surface part.

3. The lifter device according to claim 2,
wherein a dimension of the engagement member in a radial direction of the rotation shaft is a value obtained by removing a gap between the engagement member and the small-diameter side outer circumferential surface part and a gap between the engagement member and the sliding surface part from a total value, the total value being a sum of a protrusion amount of the rotation shaft-side protrusion from the small-diameter side outer circumferential surface part, a protrusion amount of the support member-side protrusion from the sliding surface part and a gap between the rotation shaft-side protrusion and the support member-side protrusion.

4. The lifter device according to claim 2,
wherein the engagement member integrally includes a ring formed concentric with the outer circumferential surface of the small-diameter side outer circumferential surface part, and
wherein the ring is configured such that an outer circumferential surface of the ring is slidable relative to a guide surface part of the support member-side protrusion facing the small-diameter side outer circumferential surface part, and an inner circumferential surface of the ring is slidable relative to an outer circumferential surface of the rotation shaft-side protrusion.

5. The lifter device according to claim 4,
wherein the support member-side protrusion includes engagement surface parts configured to engage with the engagement member at two end parts in the rotation direction of the rotation shaft,
wherein a circumferential angle of the sliding surface part of the support member interposed between the two engagement surface parts is smaller than 180 degrees, and
wherein an inner diameter of the guide surface part is enlarged on an adjacent side of the guide surface part to each of the engagement surface parts, such that the ring is movable off the guide surface part toward the sliding surface part side.

6. The lifter device according to claim 1,
wherein the rotation drive mechanism is configured to rotationally drive the rotation shaft in a lifting direction or a lowering direction by transmitting an operation force of the operation handle to the rotation shaft when the operation handle is operated to lift or lower the seat,
wherein the lock mechanism allows the rotation of the rotation shaft and is configured to lock the rotation of the rotation shaft at an operation end position of the operation handle when the operation handle is operated to lift or lower the seat,
wherein the rotation shaft-side protrusion protrudes radially from the outer circumferential surface of the rotation shaft,
wherein the engagement member is an engagement piece slidably supported on the outer circumferential surface of the rotation shaft and configured to engages with the rotation shaft-side protrusion in the circumferential direction,
wherein the stopper includes a sliding surface part which faces the outer circumferential surface of the rotation shaft via a gap capable of slidably sandwiching the engagement piece and is concentric with the outer circumferential surface of the rotation shaft,
wherein the support member-side protrusion is provided on the support member corresponding to an inner circumferential side of the sliding surface part at a position radially away from the rotation shaft, and configured to engage with the engagement piece without being engaged with the rotation shaft-side protrusion in the circumferential direction, and
wherein, when the seat is at the upper limit position or the lower limit position, the rotation of the rotation shaft is restricted by engaging an end part of the rotation shaft-side protrusion and an end part of the support member-side protrusion, which face each other in the circumferential direction, while the engagement piece is sandwiched between the rotation shaft-side protrusion and the support member-side protrusion.

7. The lifter device according to claim 6,
wherein the support member is formed to have a circular container shape, and includes inner teeth that form a portion of the lock mechanism on an inner circumferential surface of an annular outer circumferential wall,
wherein the rotation shaft is rotatably inserted into a center of the circular shape of the support member,
wherein the lock mechanism includes a lock plate that is coupled to the rotation shaft so as to rotate in synchronization with the rotation shaft in a state of being inserted into the circular container shape of the support member, and holds a pawl, at an outer circumferential side of the lock plate, that locks the rotation of the rotation shaft by engaging with the inner teeth, and
wherein the sliding surface part is formed on the lock plate.
